(19) United States
(12) Patent Application Publication
(10) Pub. No.: US 2026/0333217 A1
(43) Pub. Date: Oct. 22, 2026

(54) METHODS FOR WTRU MEASUREMENTS IN ENERGY SAVINGS NETWORKS

(71) Applicant: INTERDIGITAL PATENT HOLDINGS, INC., Wilmington, DE (US)

(72) Inventors: Faris Alfarhan, Montreal (CA); Oumer Teyeb, Montreal (CA); Paul Marinier, Brossard (CA); Virgil Comsa, Montreal (CA)

(73) Assignee: INTERDIGITAL PATENT HOLDINGS, INC., Wilmington, DE (US)

(21) Appl. No.: 19/116,687

(22) PCT Filed: Sep. 28, 2023
(86) PCT No.: PCT/US2023/034031

§ 371 Date: Mar. 28, 2025

Related U.S. Application Data
(60) Provisional application No. 63/410,971, filed on Sep. 28, 2022.
(60) Provisional application No. 63/445,568, filed on Feb. 14, 2023.

(51) Int. Cl. H04W 52/02; H04W 24/08

(52) U.S. Cl. CPC H04W 52/0209; H04W 24/08

(57) ABSTRACT

The present system and method includes WTRU measurements, mobility, carrier reselection for WTRU capable of operating in a network employing energy savings techniques. The system and method include connected mode procedures/behaviors for WTRUs operating in NES cells, including mobility and related measurements. The system and method include-idle/inactive mode procedures/behaviors for WTRUs such as cell re-selection. The present system and method include mobility and cell reselection measurements methods for triggering inter-cell/frequency/RAT measurements upon determining NES state changes.

### CROSS REFERENCE TO RELATED APPLICATIONS

This application claims the benefit of U.S. Provisional Application Ser. No. 63/410,971, filed Sep. 28, 2022, and U.S. Provisional Application Ser. No. 63/445,568, filed Feb. 14, 2023, which are incorporated by reference as if fully set forth.

### BACKGROUND

There is a motivation is to study enhancements enabling the network to minimize its power consumption from transmission and reception. Such minimization is beneficial for reducing operational costs and environmental sustainability. Compared to earlier systems, the design of NR is very efficient from the perspective of minimizing transmissions from the network when there is no data. For example, always-on cell-specific reference signal (CRS) is not used in NR. However, there is still potential for energy consumption reduction.

### SUMMARY

The present system and method includes WTRU measurements, mobility, carrier reselection for WTRU capable of operating in a network employing energy savings techniques. The system and method include connected mode procedures/behaviors for WTRUs operating in NES cells, including mobility and related measurements. The system and method include an idle/inactive mode procedures/behaviors for WTRUs such as cell re-selection. The present system and method include mobility and cell reselection measurements methods for triggering inter-cell/frequency/RAT measurements upon determining NES state changes.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates the time-frequency structure of an SSB;

FIG. 3 an example of beam sweeping;

FIG. 4 illustrates a conditional handover configuration and execution;

FIG. 5 illustrates a procedure for cell selection and re-selection;

FIG. 6 illustrates an example;

FIG. 7 illustrates a method for WTRU measurements in an energy savings network; and

FIG. 8 illustrates a method performed in a WTRU.

### DETAILED DESCRIPTION

As set forth above, enhancements enabling the network to minimize its power consumption from transmission and reception are desired. Such minimization is beneficial for reducing operational costs and environmental sustainability. Compared to earlier systems, the current design of NR is very efficient from the perspective of minimizing transmissions from the network when there is no data. For example, always-on cell-specific reference signal (CRS) is not used in NR. There is still additional potential for energy consumption reduction.

For example, the network consumes energy when not transmitting from other activities such as baseband (digital) processing for reception or beamforming. Such “idle” power consumption is not negligible in dense networks even when no WTRU is served during a given period. If the network could turn off these activities when not transmitting to a WTRU, energy consumption could be reduced.

In addition, NR supports beamforming with many ports (up to 64 transmit and receive ports) and the energy consumption increases with the number of ports utilized. The utilization of maximum number of ports may not be necessary for all WTRUs in practice. If the network adapts the number of ports to only what is required, energy consumption could be reduced.

Network energy savings may aim to improve the operation of the cellular eco-system to enable more efficient adaptation of network transmissions and receptions resources in the time, frequency, spatial, and power domains, with potential support, feedback, and assistance from WTRU. This enables an echo-friendly WTRU operation that allows deployment of greener network deployments that allow reduced emissions and Opex costs of operating cellular networks. Unlike LTE, NR does not require transmission of always-on synch or reference signals and supports adaptable bandwidth and MIMO capabilities. While initial work in this area is not expected to impact legacy WTRUs, it is also realized that adaptation of network resources may enable greater efficiency in operating newer deployments and later generations.

A system, WTRU and method for performing WTRU measurements in energy savings networks are described. The method may performed in a wireless transmit receive unit (WTRU). The method includes receiving configuration information indicating one or more measurement configurations where each of the one or more measurement configurations includes NES state information that indicates one or more network energy saving (NES) states to which the measurement configuration is applicable, receiving signaling associated with activating a first NES state of the indicated one or more NES states, determining a measurement configuration applicable to the first NES state based on the received information, performing one or more measurements using the determined measurement configuration, and reporting the one or more measurements. The measurements are performed during a time period that is configured for the first NES state. The measurements are reported during a time period that is configured for the first NES state. The signaling associated with activating the first NES state may indicate at least one selected from the group consisting of activation of the first NES state, when the first NES state is to be activated, and a time period during which the first NES state can be activated. The signaling associated with activating the first NES state may include a conditional handover (CHO) configuration associated with the first NES state. The signaling associated with activating the first NES state may include a conditional handover (CHO) reconfiguration associated with the first NES state. The method may include receiving signaling associated with activating a second NES state of the indicated one or more NES states. The method may include deactivating the first NES state and may include utilizing one or more measurement configurations not associated with any NES state. The one or more measurements may include at least one measurement of a neighbor cell.

The wireless transmit receive unit (WTRU) includes a processor and a transceiver communicatively coupled to the processor. The processor and transceiver operating to receive configuration information indicating one or more measurement configurations where each of the one or more measurement configurations includes NES state information that indicates one or more network energy saving (NES) states to which the measurement configuration is applicable, receive signaling associated with activating a first NES state of the indicated one or more NES states, determine a measurement configuration applicable to the first NES state based on the received information, perform one or more measurements using the determined measurement configuration, and report the one or more measurements. The measurements may be performed during a time period that is configured for the first NES state. The measurements may be reported during a time period that is configured for the first NES state. The signaling associated with activating the first NES state may indicate at least one selected from the group consisting of activation of the first NES state, when the first NES state is to be activated, and a time period during which the first NES state can be activated. The signaling associated with activating the first NES state may include a conditional handover (CHO) configuration associated with the first NES state. The signaling associated with activating the first NES state may include a conditional handover (CHO) reconfiguration associated with the first NES state. The processor and transceiver may be further configured to receive signaling associated with activating a second NES state of the indicated one or more NES states. The processor and transceiver may be further configured to deactivate the first NES state. The processor and transceiver may be further configured to utilize one or more measurement configurations not associated with any NES state. The one or more measurements may include at least one measurement of a neighbor cell.

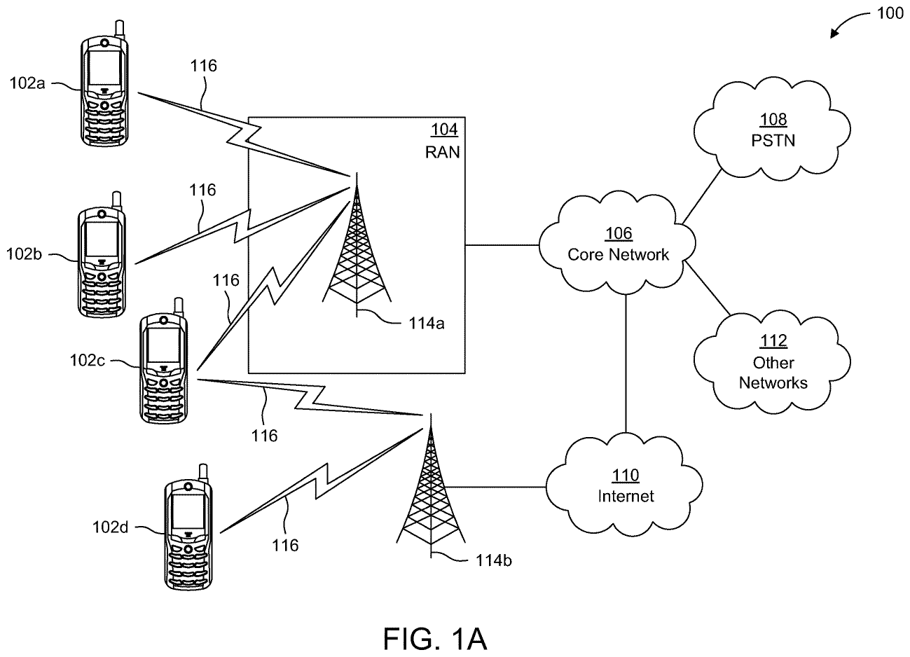

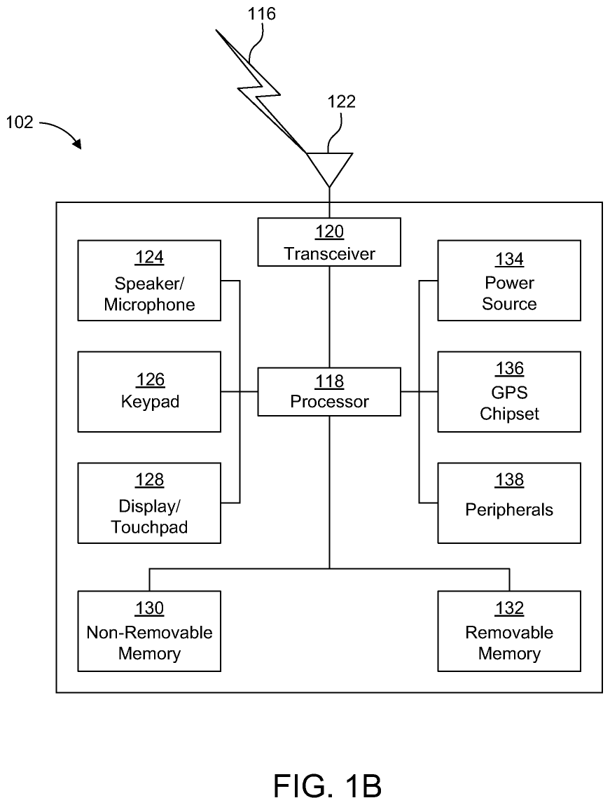

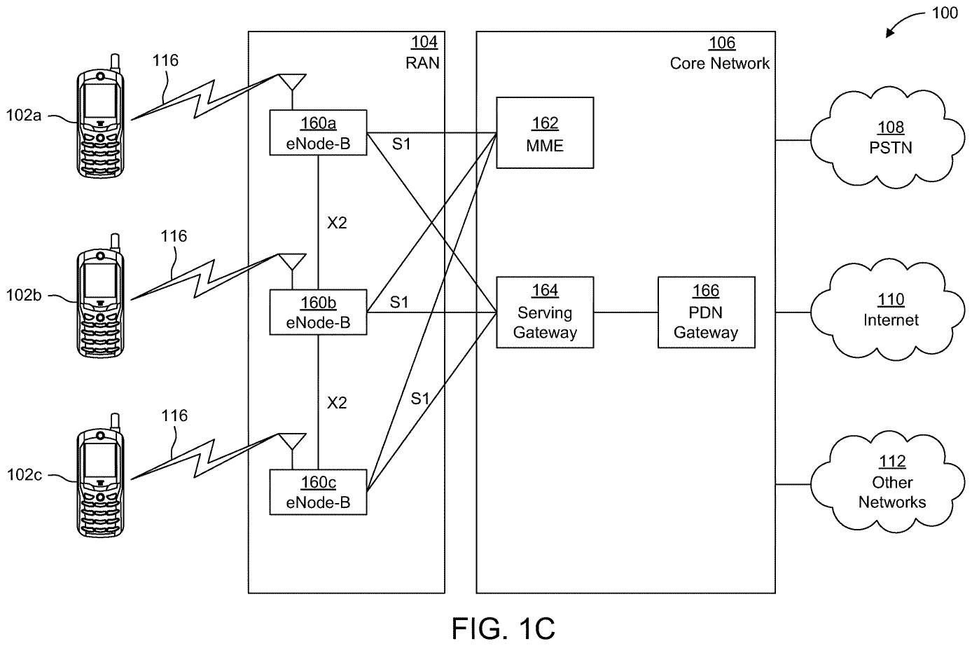

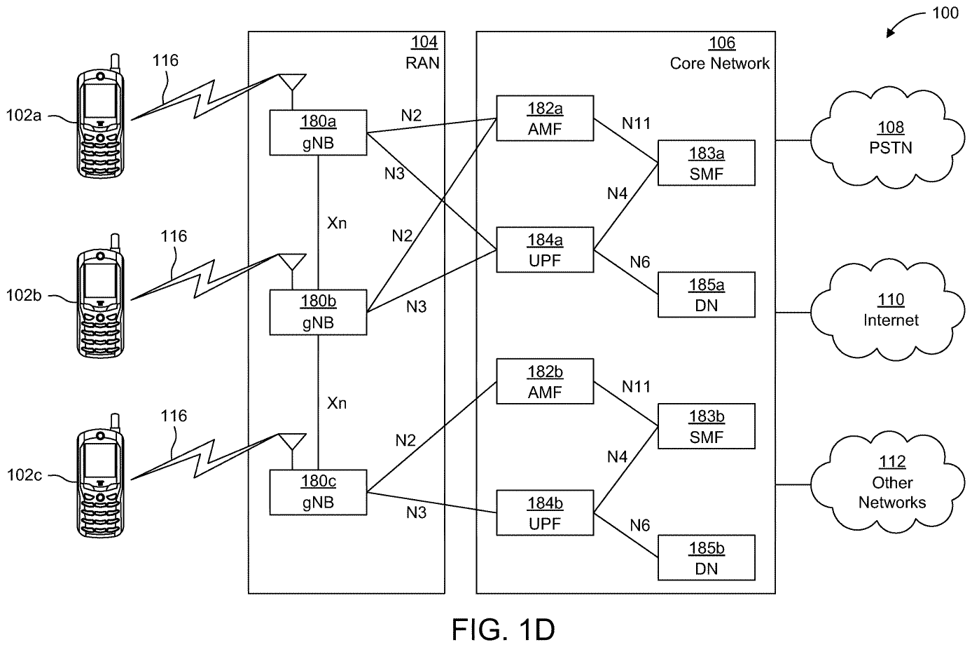

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Channel state information (CSI) may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS or SS/PBCH block.

Uplink control information (UCI) may include: CSI, HARQ feedback for one or more HARQ processes, Scheduling request (SR), Link recovery request (LRR), CG-UCI and/or other control information bits that may be transmitted on the PUCCH or PUSCH.

Channel conditions may be any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, and/or channel availability in unlicensed spectrum (e.g., whether the channel is occupied based on determination of an LBT procedure or whether the channel is deemed to have experienced a consistent LBT failure).

PRACH resource includes a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random-access procedure.

A property of scheduling information (e.g., an uplink grant or a downlink assignment) may include one or more of: a frequency allocation; an aspect of time allocation, such as a duration; a priority; a modulation and coding scheme; a transport block size; a number of spatial layers; a number of transport blocks to be carried; a TCI state or SRI; a number of repetitions; and whether the grant is a configured grant type 1, type 2 or a dynamic grant.

An indication by DCI, or an indication, may include one or more of: an explicit indication by a DCI field or by RNTI used to mask CRC of the PDCCH; an implicit indication by a property such as DCI format, DCI size, Coreset or search space, aggregation level, identity of first control channel resource (e.g., index of first CCE) for a DCI, where the mapping between the property and the value may be signaled by RRC or MAC; and an explicit indication by a DL MAC CE.

The terms network availability state and NES state may be used interchangeably.

NR System Information (SI) includes a MIB (master Information block) and a number of SIBs (System Information Blocks). The SIBs are divided into Minimum SI and Other SI. Minimum SI carries information required for initial access and for acquiring any other SI. Minimum SI consists of MIB and SIB1. For a WTRU to be allowed to camp on a cell, it must have acquired the contents of the minimum SI of that cell. Other SI includes SIBs not broadcasted in the Minimum SI. The WTRU does not need to receive these SIBs before accessing the cell. Other SI is also known as On-Demand SI because the gNB may transmit/broadcast these SIBs only when explicitly requested by WTRU(s). This is for network energy saving purposes.

MIB may contain cell barred status information and essential physical layer information of the cell required to receive further system information, e.g., CORESET #0 configuration. MIB is periodically broadcast on BCH (the periodicity is 80 ms and within the 80 ms, repetitive transmission could happen).

SIB1 may define the scheduling of other system information blocks and contains information required for initial access. SIB1 is also referred to as Remaining Minimum SI (RMSI) and is periodically broadcast on DL-SCH or sent in a dedicated manner on DL-SCH to WTRUs in RRC_CONNECTED.

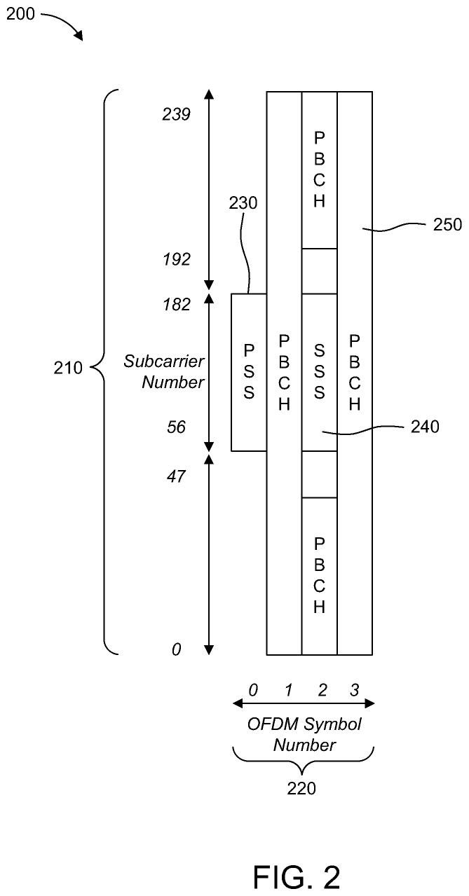

FIG. 2 illustrates the time-frequency structure of a synchronization signal block (SSB) 200. SSB 200 occupies 240 subcarriers 210 in the frequency-domain and 4 symbols 220 in the time-domain. SSB 200 includes the primary synchronization signal (PSS) 230, the secondary synchronization signal (SSS) 240, and the physical broadcast channel (PBCH) 250. PSS 230 and SSS 240, each occupy 1 symbol and 127 subcarriers. PBCH 250 may span across 3 OFDM symbols and 240 subcarriers. As illustrated in FIG. 2, one symbol in the middle of PBCH 250 may be unused for SSS 240. PSS 230 and SSS 240 may provide the physical cell identity (PCI), and PBCH 250 may carry the master information block (MIB) plus additional payload bits.

The possible time locations of SSBs 200 within a half-frame are determined by sub-carrier spacing and the periodicity of the half-frames where SSBs 200 are transmitted is configured by the network. During a half-frame, different SSBs 200 may be transmitted in different spatial directions (i.e., using different beams, spanning the coverage area of a cell). Within the frequency span of a carrier, multiple SSBs 200 can be transmitted. The PCIs of SSBs 200 transmitted in different frequency locations do not have to be unique, i.e. different SSBs 200 in the frequency domain can have different PCIs. However, when an SSB is associated with an RMSI, the SSB is referred to as a Cell-Defining SSB (CD-SSB). A PCell is always associated to a CD-SSB located on the synchronization raster.

The WTRU may assume a band-specific sub-carrier spacing for the SSB 200 unless a network has configured the WTRU to assume a different sub-carrier spacing. Several beams may be associated with a given, and multiple SSBs 200 can be transmitted within a given cell on different beams (i.e., beam sweeping).

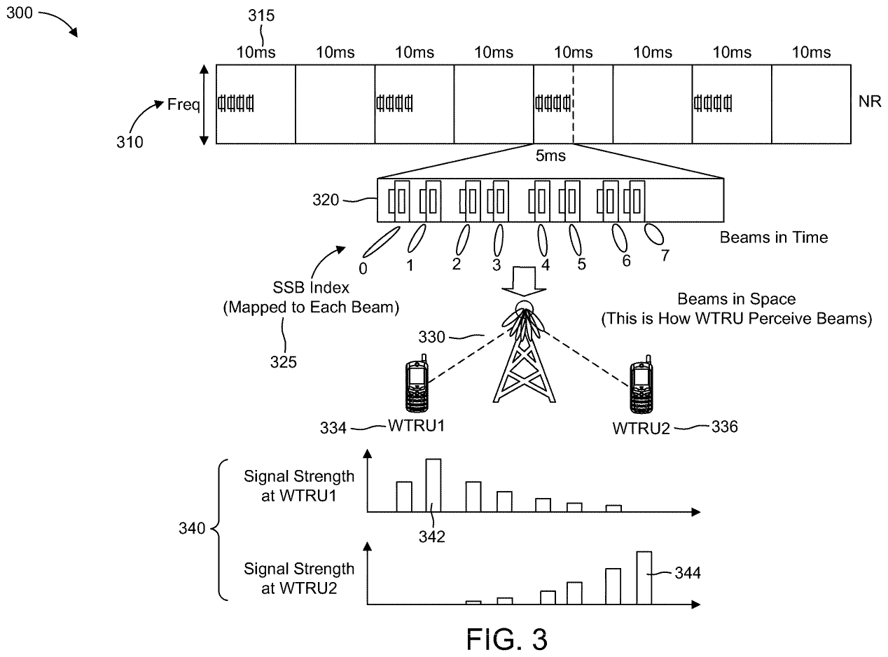

FIG. 3 an example of beam sweeping 300. Periodically broadcast SSBs 310 may be periodically transmitted from each cell. The SSBs may be organized in burst sets, each burst set including one or more SSBs. The number of SSBs may be configured, such that for higher frequencies, for example, 64 may be used. Each SSB has an index 325 that increases from 0 to the number of SSBs minus 1. The periodicity 315 is illustrates as 10 ms in FIG. 3. This periodicity 315 may range from 5 ms to 160 ms.

FIG. 3, via beam sweeping 300, illustrates multiple SSBs 320 (8 SSBs-indexed 325 from 0-7) are being transmitted with a certain interval. Each SSB may be identified by SSB index 325, with each SSB transmitted via a specific beam radiated in a certain direction. Multiple WTRUs, illustrated as WTRU 334 and WTRU 336, are located at various places around a gNB 330. Each WTRU 334, 336 measures the signal strength of each SSB it detected for a certain period (a period of one SSB Set). From the measurement result, each WTRU 334, 336 may identify the SSB index with the strongest signal strength using the measured signal strength plots 340. For the example, as illustrated further in FIG. 3, Beam #1 342 is the best beam (the selected beam) for WTRU 1 334 and Beam #7 344 is the best beam for WTRU 2 336.

The number of different beams transmitted may be determined by how many SSBs are being transmitted within an SSB Burst Set (a set of SSBs being transmitted in 5 ms window of SSB transmission). In FR1, the maximum number of SSBs within an SSB set is 4 or 8, while for FR2 it can be 64, for example.

There may be Network Availability States/NES states. The WTRU may determine whether the WTRU can transmit or receive on certain resources depending on a network availability state, which implies the gNB's power savings status. An availability state may correspond to a network energy savings state or a gNB activity level. An availability state may be uplink or downlink specific, and may change from symbol to symbol, slot to slot, frame to frame, or on longer duration granularity. The availability state may be determined by the WTRU or indicated by the network. An availability state can be, for example, “On”, “DL and UL active”, “UL only active”, “off”, “reduced Tx power”, “dormant”, “micro sleep”, “light sleep”, or “deep sleep”. Such states can be abstracted by NW configuration parameters and/or values, and dynamic indication may point to the active availability state (e.g., by DCI or MAC CE signaling). The “Off” availability state may imply that the gNB's baseband hardware is completely turned off. The “sleep” availability state may imply that the gNB wakes up periodically to transmit certain signals (e.g., presence signals, synchronization, or reference signals) or receive certain UL signals. In some availability states, some DL or UL resources are not available during certain periods of time, and this enables the network to turn off baseband processing and other activities. Some measurement resources (e.g., SSBs or CSI-RS) may only be made available in certain availability states, including: RLM, BFD, RRM measurements, CSI-RS feedback configuration, and/or a different power offset for CSI feedback.

Under certain conditions, the WTRU may further transmit a request to the network (wake-up request) to modify the availability state to a state for which resources that would satisfy WTRU requirements are available. Such a wake-up request may include a transmission that may be decodable by a low-complexity receiver at the gNB for which energy consumption requirement is minimal. The wake up request, turn on request, or switch on WTRU assistance information may be used interchangeably. In certain availability states (e.g., “micro sleep” or “deep sleep”), wake up request may be exclusively used and may refer to a physical uplink signal transmitted by the WTRU to request a change of availability state. The physical layer design of a wake-up request signal is detailed. A switch on request may otherwise be a physical layer or an L2 indication from the WTRU to the network, which may be delivered as a MAC CE, UCI, RRC signaling or RRC reconfiguration signaling—e.g., applicable for NES-, PUCCH, or RACH indication, and may include switch on WTRU assistance information and/or a positioning report.

The WTRU may determine an availability state from reception of availability state indication from e.g., by L1/L2 signaling (e.g., a group common DCI or indication), or implicitly determine it form the reception of periodic DL signaling- or lack thereof-.

The WTRU may determine if a resource is available for transmission/reception and/or measurements for the determined network availability state if it is applicable in the active availability state. In addition, the WTRU may also adapt its active C-DRX cycle, active spatial elements (e.g., antenna or logical ports), active TRPs, paging occasions as a function of the signaled or determined NES state. The WTRU may be configured with one or more sets of NES transmission and/or reception parameters per NES state, e.g., by broadcast or dedicated configuration signaling. The WTRU may apply the NES parameter set according to the determined or signaled NES state. The WTRU may apply one or more applicable configurations depending on the determined NES state. A set of NES parameter may include one or more of: a number of antenna ports, a C-DRX configuration, a measurement configuration (e.g., for RRM, RLM, and/or BFD), CSI feedback, a CSI-RS configuration, an SSB configuration, CHO or mobility candidates, a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the WTRU may receive an availability state change indication indicating that this change is just for that cell, for all cells at the same frequency, or/and same RAT.

The WTRU may consider the active availability state associated with a cell, carrier, TRP, or frequency band to be “Off”, “Deep sleep”, or “Micro sleep” after reception of a DL signaling that changes the cell's or TRP's availability state. For example, the WTRU may receive a turn off command on broadcast signaling, RRC signaling, DCI (e.g., a group common DCI), or a DL MAC CE (e.g., indication part of PDSCH). The WTRU may determine an availability state from reception of availability state indication from e.g., by L1/L2 signaling (e.g., a group common DCI or indication).

For example, the WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply, or may determine a delta configuration from the current set of parameters upon determining an NES state change. The WTRU may transmit feedback/acknowledgment to gNB, possibly multiplexed with UL data (e.g., part of an UL TB as a MAC CE or a sub-header indication), following the reception of NES state change indication.

Also, for example, the WTRU may determine a change of NES state change from the reception of broadcast signaling associated with NES state indication or change, including signaling in SIB(s) or part of a broadcast or multicast PDSCH. The WTRU may be indicated the NES state explicitly in the SIB. The WTRU may be configured with one or more SIBs exclusively associated with configuration of NES parameters. The WTRU may be configured to receive such broadcast or multicast indication periodically; the WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

The WTRU may implicitly assume a certain availability state associated with a cell, carrier, TRP, or frequency band (e.g., “Off, “deep sleep”, “micro sleep” or dormant”) from at least one of the following.

The WTRU may assume a certain availability state from the reception of a command or signal indicating a change in availability state, e.g., a group common DCI in connected mode or RRC signaling or a presence signal. The WTRU may determine an availability state implicitly form the reception of periodic DL signaling. The WTRU may be configured or specified to associate an availability state with one or more DL signal type (e.g., SSB, partial SSB, and/or one or more periodicity.

The WTRU may assume a certain availability state from the reception of a paging message, paging DCI, paging PDSCH, or a paging related signal (e.g., PEI), possibly on a subset of POs (e.g., those aligned with NES drx cycle or a configured subset of PDCCH resources). The WTRU may assume a certain availability state after reception of an indication part of the DCI or PDCCH scheduling paging (e.g., as a function of the P-RNTI, NES-RNTI or based on receiving an explicit indication—e.g., on a reserved bit). The WTRU may assume a certain availability state after the reception of a paging message with a certain P-RNTI, a separately configured NES P-RNTI, or the NES group RNTI. The WTRU may assume a certain availability state after the reception of a paging message with a certain P-RNTI. The WTRU may be configured with one more PEI subgroup for NES, where a subgroup may be associated with one or more availability state. The WTRU may assume a certain availability state after reception of a PEI with an NES subgroup, possibly if that subgroup is configured and/or associated with the availability state. The indication of the availability state or the availability state switch may be indicated in the paging payload, e.g., as a flag part of the paging message or the short message. Such paging indication may further indicate an alternate cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable SI cycle, and/or the applicable cell(s) and associated availability states).

The WTRU may assume a certain availability state from the gNB DTX status (whether the gNB is in active time or an associated activity timer is running).

The WTRU may assume a certain availability state from the lack of detection of a presence indication including the WTRU determining an availability state associated with the cell (e.g., “off” or “deep sleep”) if presence indication was not detected on one or more presence indication occasion, the WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode only, or also in other states (e.g., idle and inactive states). The WTRU may determine an availability state implicitly form the lack of reception of periodic DL signaling. For example, the WTRU may be configured with a signal quality threshold (e.g., an RSRP threshold) and if the WTRU does not detect a signal associated with an availability state (e.g., a presence signal or an SSB) with a signal strength above the threshold, the WTRU may assume that this availability state is not active and may assume a different availability state. This criterion can be also coupled with lack of detection of an identifying sequence of the presence signal (e.g., detection of the PSS sequence for example).

The WTRU may assume a certain availability state based on time in the day. For example, the WTRU may be configured to automatically assume a certain availability state (e.g., off, sleep, or dormant) for a configured subset of cells (e.g., capacity boosting cells) depending the time in the day. For example, the WTRU may determine that a capacity boosting cell has an availability state as “On” in certain hours of the day, “Deep sleep” in other configured hours, and “Off” in a third set of configured hours of the day or night.

The WTRU may assume a certain availability state based on the availability state of an associated cell (e.g., another carrier of the same MAC entity, another carrier in the same cell group, another carrier in the same gNB, another sector in the same gNB, or a configured associated cell or capacity boosting cell).

The WTRU may assume a certain availability state from the detection of a PSS only signal or a simplified/stripped down SSB signal.

The WTRU may assume a certain availability state from the detection of an RS signal (e.g., CSI-RS, PRS, TRS) or the lack thereof.

The WTRU may assume a certain availability state from the WTRU's RRC state (Idle, inactive, or connected mode).

The WTRU may assume a certain availability state from whether paging has been received, possibly within a configured time window.

The WTRU may assume a certain availability state from whether system information (e.g., periodic SI or a subset of SIBs) have been received, possibly within a configured time window.

The WTRU may assume a certain availability state from the measured channel condition(s) being below- or above-a threshold. The WTRU may assume a change of NES state based on a change of measured channel conditions or making a channel measurement below- or above-a threshold. For example, the WTRU may use degradation in measurements of SSBs or CSI-RS, possibly in combination with other signaling—to determine the NES state. For example, a configured window following the DCI reception can be used to measure SSBs and/or CSI-RS for degradation, and if a delta of SSB-RSRP drop is measured the WTRU may determine that the NES state has changed and assume associated actions for such NES state (e.g., trigger for CHO candidate selection or for group scheduling for a mobility command).

The WTRU may be configured to monitor an indication that may characterize the level of network activity (e.g., an availability state). The network activity may be associated with a gNB and/or a cell. The WTRU may assume the same availability state for all cells part of the same gNB, e.g., cells of the same MAC entity. The network activity indication (e.g., the presence indication) may include a channel (e.g., a PDCCH) and/or a signal (e.g., a sequence). The activity indication or the NES state change indication/command may indicate the level of activity the WTRU may expect from the associated gNB and/or cell, e.g., reduced activity. The activity indication may contain activity information of other gNBs/cells. The activity indication may be a PDCCH containing group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI or an NES-RNTI” A WTRU may be configured with at least one search space associated with the monitoring occasions of the activity indication PDCCH. The indication may consist of a go-to-sleep signal, e.g., a predefined sequence. When WTRU detects this sequence, WTRU may expect a reduced activity level over a specific time duration. The WTRU may activate C-DRX for the period of time indicated. Alternatively, two sequences may be used to indicate regular activity and reduced activity.

The signaling within the PDCCH or the activity indication may contain at least one of the following.

The signaling within the PDCCH or the activity indication may include expected activity level of the associated gNBs/cells over a specific time interval (e.g., an availability state). The activity levels may be predetermined and/or configured and may, for example, consist of regular and reduced activity. The signaling may indicate the activity level. For example, bit “1” may indicate regular activity and bit “0” may indicate reduced activity.

The signaling within the PDCCH or the activity indication may include, for each activity level (e.g., availability state), transmission and reception attributes may be defined. For example, during reduced activity, WTRU may not be expected to monitor certain PDCCH search spaces (including all SSs), and/or receive a certain type of PDSCH (including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de) activated TRPs or spatial elements.

The signaling within the PDCCH or the activity indication may include a set of configurations may be associated with an activity level and may be used/applied when that activity level is indicated (e.g., an NES parameter set). For example, SS configurations, CSI reporting configurations, indices of transmitted SSBs, etc. Each set of configurations may have an attribute associated with an activity level. For example, a tag that can be set to “reduced activity”.

The signaling within the PDCCH or the activity indication may include the time interval over which an activity level is assumed may be signaled in the PDCCH or part of the activity indication. The time interval may be indicated using a bitmap where each bit in the bitmap may be associated with a specific duration, e.g., a slot or a frame. For example, bit “1” may indicate regular activity and bit “0” may indicate reduced activity on an associated frame. The time interval may be indicated with a start time and length of interval. The start time may be defined; for example, it may be determined by adding a fixed offset to the time the indication is received. The length of the interval may be configured or signaled in the indication PDCCH.

The signaling within the PDCCH or the activity indication may include the time interval over which an activity level is assumed may be predetermined. The WTRU may assume an interruption delay (or more generally a time till the NES state changes) after the NES state change command reception (e.g., after the last symbol or slot on which the command was received). The interruption time can be in absolute time, a number of symbols, or a number of slots.

The WTRU may perform mobility to another serving cell, trigger mobility related measurements, and/or start evaluating CHO candidates on alternate cells upon determining an NES change. The WTRU may be configured or predefined with an alternate serving cell to perform initial access, mobility, or cell reselection on in the event the current serving cell or a capacity boosting cell is turned off or a certain condition is met. The WTRU may be configured per broadcast or dedicated signaling with a list of fallback or alternate serving cells, possible per serving cell or per gNB. For example, the WTRU may initiate a cell reselection or mobility procedure to an alternate serving cell associated with a cell or gNB from which a turn-off indication was received. In one example, the turn off or go-to-sleep indication may dynamically indicate to the WTRU which cell to fallback or connect to, e.g., by dedicated or broadcast signaling. The fallback/alternate cell can be configured or predefined to be a cell within the same gNB from which a sector has entered NES state (e.g., off, sleep, or reduced power). In another example, the fallback cell may be predefined as the master node cell if the WTRU is in dual connectivity. The fallback/alternate cell can be configured or predefined to be a cell associated with a different RAT or frequency band. For example, the WTRU may fallback to an LTE or an FR1 cell associated with the cell or gNB from which the turn off indication was received (e.g., if the WTRU is in CA or DC using multiple RATs or multiple frequency bands).

The WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals only in a subset of NW availability states (e.g., SRS, pSRS, PRACH, UCI).

NES WTRU groups may be provided. WTRUs may be grouped for the purpose of NES, e.g., to control a number of WTRUs simultaneously, e.g., to indicate a bwp switch, to indicate a change of NW availability state, to indicate a change to the WTRU DRX cycles/parameters, for mobility/cell re-selection, paging, and/or activation/deactivation of DL measurement resources. For such purposes, the WTRU may be configured with a NES group RNTI (more generally an NES group identifier), which can be used to signal one or more WTRUs in the same serving cell. The WTRU may monitor a cell specific DL resource for reception of control and/or data, to receive group common indications for NES (e.g., group common DCI, an availability state switch command, an NES PCell switch command).

The WTRU may monitor for reception of a presence of an indication or signal (such as the Cell presence indication) associated with a gNB configured with one or more availability state (e.g., On, off, dormant, and/or deep sleep). The presence indication can be a physical downlink signal transmitted by the associated cell or gNB that is sleeping, e.g., possibly in certain availability states (e.g., deep sleep, micro sleep, dormant, or off). Alternatively, the presence indication may be downlink information bits that are delivered to the WTRU, e.g., by broadcast signaling (e.g., SIB), or by dedicated signaling (e.g., RRC signaling or MAC CE).

The WTRU may change to the availability state associated with detecting a presence signal (e.g., WTRU assume “On”) after it successfully receives a response from the requested cell to the transmitted WTRU assistance information or switch-on request, where the response can be the reception of a DL signal or channel (e.g., SSB(s), CSI-RS, PRS, PDCCH, DCI, PDSCH, HARQ-ACK) or an L2 message (e.g., an RRC message, DL MAC CE, Msg2, MsgB, or Msg4). The WTRU may start monitoring additional TRPs, SSBs and/or CSI-RS resources after the transmission of the wake-up WTRU assistance information or the switch-on request or successful reception of the response to it. The WTRU may change to the availability state associated with detecting a presence signal (e.g., On) after it successfully measures channel conditions (e.g., RSRP, SINR) on measurement resources of the associated cell above a configured threshold.

The presence indication signal can be at least one of the following: a simplified or stripped down SSB signal, e.g., PSS/SSS without PBCH multiplexed, a wide beam or omni-directional SSB, a PRS, a CSI-RS, a signal detected based one energy sensing the ether (e.g., a DL signal associated with a wake-up radio, if the WTRU is capable is capable of such hardware to detect it), a PDSCH, or PDCCH received on a different cell or TRP, possibly on a configured subset of resources, coresets, or search spaces, and/or one or more SSBs received on a different cell or TRP, possibly configured on a subset of SSB occasions.

NR includes the concept of conditional handover (CHO) and conditional PSCell Addition/Change (CPA/CPC, or collectively referred to as CPAC), with the main aim of reducing the likelihood of radio link failures (RLF) and handover failures (HOF). Legacy LTE/NR handover is typically triggered by measurement reports, even though there is nothing preventing the network from sending a HO command to the WTRU even without receiving a measurement report. For example, the WTRU is configure with an A3 event that triggers a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). The WTRU monitors the serving and neighbor cells and may send a measurement report when the conditions get fulfilled. When such a report is received, the network (current serving node/cell) may prepare the HO command (basically, an RRC Reconfiguration message, with a reconfigurationWithSync) and sends it to the WTRU, which the WTRU executes immediately resulting in the WTRU connecting to the target cell.

CHO differs from legacy handover in two main aspects. First, multiple handover targets are prepared (as compared to only one target in legacy case), and second, the WTRU does not immediately execute the CHO as in the case of the legacy handover. Instead, the WTRU is configured with triggering conditions a set of radio conditions, and the WTRU executes the handover towards one of the targets only when/if the triggering conditions are fulfilled.

The CHO command may be sent when the radio conditions towards the current serving cells are still favorable, thereby reducing the two main points of failure in legacy handover, i.e. risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command).

The triggering conditions for a CHO could also be based on the radio quality of the serving cells and neighbor cells like the conditions that are used in legacy NR/LTE to trigger measurement reports. For example, the WTRU may be configured with a CHO that has an A3 like triggering conditions and associated HO command. The WTRU monitors the current and serving cells and when the A3 triggering conditions are fulfilled, it may, instead of sending a measurement report, executes the associated HO command and switches its connection towards the target cell.

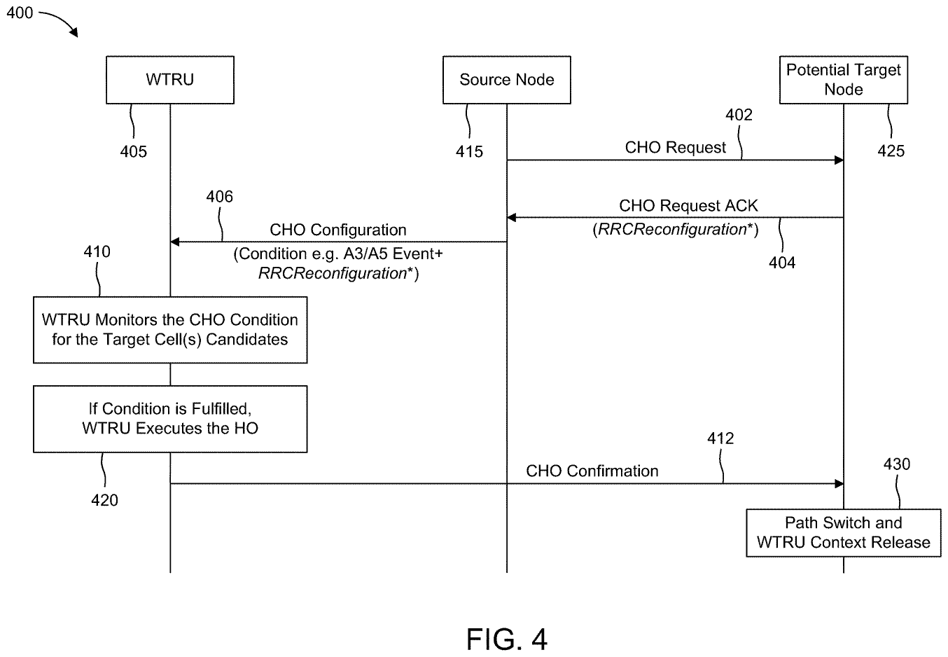

FIG. 4 illustrates a signaling diagram 400 for a conditional handover configuration and execution. Signaling diagram includes a WTRU 405, a source node 415 and a potential target node 425 in communication. Source node 415 may signal at the potential target node 425 with a CHO request at 402. At 404, potential target node 425 provides a CHO request acknowledgement to source node 415 at 404. This CHO request acknowledgement may be a RRCReconfioguiration message in some examples. Source node 415 signals WTRU 405 a CHO configuration at 406. The CHO configuration may include a condition that triggers the CHO. For example, the condition may be a A3/A5 event and may additionally include RRCReconfiguration messaging.

WTRU 405 may monitor the CHO condition provided in message 406 for the target cell candidate or candidates at 410. If the condition is fulfilled, WTRU 405 executes the HO to that target cell meeting the condition at 4210. WTRU 405 sends a CHO confirmation to the potential target node 425 at 412. Potential target node 426 performs a path switch and WTRU context release at 430.

CHO may aid in prevent unnecessary re-establishments in case of a radio link failure. For example, assume the WTRU is configured with multiple CHO targets and the WTRU experiences an RLF before the triggering conditions with any of the targets gets fulfilled. Legacy operation would have resulted in RRC re-establishment procedure that would have incurred considerable interruption time for the bearers of the WTRU. However, in the case of CHO, if the WTRU, after detecting an RLF, ends up a cell for which it has a CHO associated with (i.e., the target cell is already prepared for it), the WTRU will execute the HO command associated with this target cell directly, instead of continuing with the full re-establishment procedure.

CPC and CPA are just extensions of CHO, but in DC scenarios. A WTRU may be configured with triggering conditions for PSCell change or addition, and when the triggering conditions are fulfilled, it may execute the associated PSCell change or PSCell add commands.

For WTRU 405 performing monitoring 410, measurement and event configurations for handover and conditional handover may be provided. The following shows some of the IE (information elements) of the measurement configuration that can be provided to the WTRU.

| | |
|---|---|
| measObjectToRemoveList | MeasObjectToRemoveList |
| measObjectToAddModList | MeasObjectToAddModList |
| reportConfigToRemoveList | ReportConfigToRemoveList |
| reportConfigToAddModList | ReportConfigToAddModList |
| measIdToRemoveList | MeasIdToRemoveList |
| measIdToAddModList | MeasIdToAddModList |
| s-MeasureConfig | CHOICE { |
| ssb-RSRP | RSRP-Range, |
| csi-RSRP | RSRP-Range |

}

| | |
|---|---|
| quantityConfig | QuantityConfig |
| measGapConfig | MeasGapConfig |

}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}

| | |
|---|---|
| ReportConfigToAddModList ::= | SEQUENCE (SIZE (1..maxReportConfigId)) OF |

ReportConfigToAddMod

| | |
|---|---|
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}

The main components of the measurement configuration include measurement objects, reporting configurations, measurement ID configurations, S-measure configuration, quantity configuration, and measurement gap configuration.

A measurement object specifies what WTRU 405 has to measure and some information regarding how the measurement is to be performed. This includes information such as the RAT, frequency, sub carrier spacing, SSB periodicity/offset/duration, reference signals and signal types to be measured, list of allowed/excluded neighbor cells of the concerned RAT/frequency to be measured, measurement gaps (occasions and durations), offset that can be applied to prioritize/de-prioritize certain cells, etc. WTRU 405 can be configured with multiple measurement objects, and WTRU 405 may have measurement configurations that can be related to different frequencies or even different RAT. WTRU 405 can be configured with up to 64 measurement objects, and each measurement object is identified by a measurement object ID.

A reporting configuration specifies what is to be reported (e.g., reference signal type such as CSI-RS or SSB, the beam and cell level quantities to be reported such as RSRP/RSRQ, maximum number of cells or/and beams to be reported, etc.,) and the reporting criteria, upon the fulfilment of which the WTRU either sends a measurement report or executes an associated HO configuration in the case of CHO. The reporting criteria can be just the expiry of a periodic timer (periodic reporting configuration) or based on some radio conditions of serving and/or neighbor cells. WTRU 405 can be configured with up to 64 reporting configurations, and each reporting configuration is identified by a reporting configuration ID.

WTRU 405 in monitoring 410 may include a measurement object can be associated with one or more reporting configurations. This association is made through a measurement ID. The measurement ID configuration is a listing of measurement ID, measurement object ID, and reporting configuration ID. WTRU 405 can be configured with up to 64 measurement IDs.

There are several ways of configuring event triggered reporting. These ways may include Event A1 (Serving cell becomes better than threshold), Event A2 (Serving becomes worse than threshold), Event A3 (Neighbor becomes offset better than SpCell), Event A4 (Neighbor becomes better than threshold), Event A5 (SpCell becomes worse than threshold1 and neighbor becomes better than threshold2), Event A6 (Neighbor becomes offset better than SCell), Event B1 (Inter RAT neighbor becomes better than threshold), and Event B2 (PCell becomes worse than threshold1 and inter RAT neighbor becomes better than threshold2). The term SpCell refers to a PCell (Primary Cell), or in the case of DC, the Primary Secondary Cell (PSCell). Event A3, A5, B2 can only be configured for the PCell or PSCell. Events A1, A2, A3, A5, B2 can be configured for any serving cell. Event A6 can be configured only for SCells (i.e., for the secondary cells in carrier aggregation, CA). Events A4 and B1 are only related to neighbor cell measurements (and thus not related to any serving cell). Each event configuration is associated with a threshold (offset), hysteresis and time ToTrigger (TTT) parameters.

In the case of CHO, instead of sending a measurement report when the reporting conditions are fulfilled, WTRU 405 executes the HO command at 420. For the sake of CHO, the following event triggered reporting configurations may be defined as CondEvent A3 (Neighbor becomes offset better than SpCell), CondEvent A4 (Neighbor becomes better than threshold), and CondEvent A5 (SpCell becomes worse than threshold1 and neighbor becomes better than threshold2).

A CHO configuration may include conditional reconfiguration ID, conditional reconfiguration triggering condition, and RRC reconfiguration to be executed when the conditions are fulfilled at 420 (i.e., HO command).

The triggering conditions being monitored by the WTRU 405 at 410 may reference to 1 or 2 measurement IDs, and if 2 measurement IDs are specified, then these two may refer to the same measurement object (e.g., one measID associating the measurement object related to the PCell with an A3 event and another measID associating the same measurement object with an A5 event). Generally, WTRU 405 can be configured with a maximum of 8 CHO configurations.

WTRU 405 measurement configuration may contain an s-measure configuration (s-MeasureConfig), which specifies a threshold for NR SpCell RSRP measurement controlling when WTRU 405 is required to perform measurements on non-serving cells. That is, when the serving cell's (e.g., PCell) RSRP is above the s-measure threshold, WTRU 405 is not required to perform neighbor cell measurements, thereby saving WTRU battery.

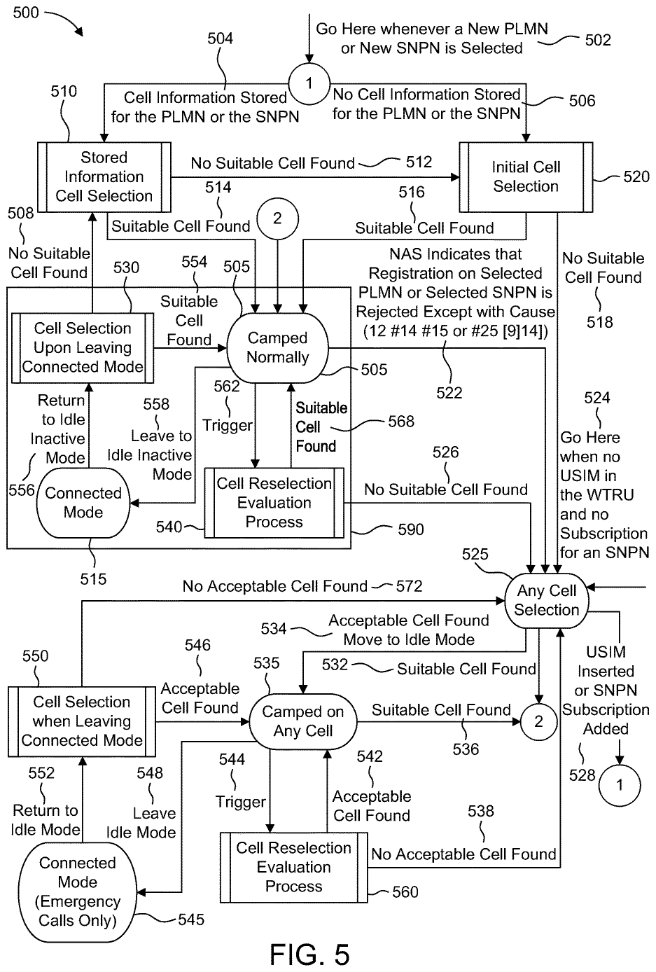

FIG. 5 illustrates a procedure 500 for cell selection and re-selection. Procedure 500 provides a summary for use in NR, for example. A starting point for procedure 500 is whenever a new PLMN or new SNPN is selected at 502. If the cell information is stored for eh PLMN or the SNPN at 504 the cell selection information is stored at 510. If no cell information is stored for the PLMNor the SNPN at 506 and initial cell reselection occurs at 520.

When storing information related to cell selection at 510, if no suitable cell is found at 512 initial cell selection 520 may occur. If a suitable cell is found at 514, the cell may be camped per normal camping at 505.

When performing initial cell selection at 520, if a suitable cell is not found at 518 any cell selection 525 may occur. If a suitable cell is found at 516, the cell may be camped per normal camping at 505.

When camping on cell normally at 505, if a trigger occurs at 562 cell reselection ad evaluation may be processed at 540, leave idle/inactive mode at 558 to connected mode 515.

From connected mode 515, a return to idle/inactive mode 556 may occur to return to cell selection upon leaving connected mode at 530. From the cell selection upon leaving connected mode at 530, if a suitable cell is found at 554, normal camping on cell at 505 may occur. If no suitable cell is found at 508, a return to storing information about cell selection at 510 may occur.

When camping normally at 505, a NAS message may indicate that registration on selected PLMN or selected SNPN is rejected at 522 and a cell selection at 525 may occur.

From cell reselection evaluation process 540, if a suitable cell is found at 568, it may be camped normally at 505. If not suitable cell is found at 526, any cell selection at 525 may occur.

From any cell selection 525, if a suitable cell is found at 532, that cell may be camped normally at 505. If a USIM is inserted or SNPN subscription added at 528, a new PLMN or new SNPN may be analyzed at 502. If an acceptable cell is found, a move to idle mode at 534 may occur, followed by camping on any cell at 535. If camping on any cell 535 determines a suitable cell is found at 536, that cell may be camped normally at 505.

When camped on any cell 535, if any trigger occurs at 544, cell reselection evaluation process may occur at 560. If the reselection 560 finds an acceptable cell at 542, that cell may be camped at 535. If no acceptable cell is found at 538 via reselection 560, any cell selection 525 may be entered.

If camped on any cell at 535 and idle mode is left at 548, connected mode for emergencies call at 545 may be entered. From there a return to idle mode at 552 may occur to enter cell selection when leaving connected mode at 550. If an acceptable cell is found at 546 during selection 550, that cell may be camped at 535. If no acceptable cell is found at 572, selection 550 may result in any cell selection 525.

As illustrated in FIG. 5 there is a box 590 within the figure that highlights the aspects related to going between RRC_CONNECTED to RRC_IDLE/RRC_INACTIVE (e.g., upon the reception of an RRC Release message or transitory cell selection done during RRC Re-establishment), and when a WTRU is able to find a suitable cell to camp on such as at 505. Also, inter-RAT cell re-selection is not considered.

When looking for a suitable cell (several times within FIG. 5), the WTRU searches the NR frequency bands and for each carrier frequency identifies the strongest cell as per the CD-SSB. The WTRU reads cell system information broadcast to identify its PLMN(s) to find a suitable cell to camp on. A suitable cell is one for which the measured cell attributes satisfy the cell selection criteria; the cell PLMN is the selected PLMN, registered or an equivalent PLMN; the cell is not barred or reserved and the cell is not part of a tracking area which is in the list of “forbidden tracking areas for roaming”. On transition from RRC_CONNECTED to RRC_INACTIVE or RRC_IDLE, a WTRU may camp on a cell as result of cell selection according to the frequency be assigned by RRC in the state transition message if any. The cell selection criterion (known as criterion S) is fulfilled based on Eq. 1 where:

Srxlev>0 AND Squal>0 Eq. 1

where Srxlev=Qrxlevmeas−(Qrxlevmin+Qrxlevminoffset)−Pcompensation−Qoffsettemp and Squal=Qqualmeas−(Qqualmin+Qqualminoffset)−Qoffsettemp and where:

| | |
|---|---|
| Srxlev | Cell selection RX level value (dB) |
| Squal | Cell selection quality value (dB) |
| Qoffsettemp | Offset temporarily applied to a cell as specified in TS 38.331 |
| | (dB) |
| Qrxlevmeas | Measured cell RX level value (RSRP) |
| Qqualmeas | Measured cell quality value (RSRQ) |
| Qrxlevmin | Minimum required RX level in the cell (dBm). If the UE |
| | supports SUL frequency for this cell, Qrxlevmin is obtained |
| | from q-RxLevMinSUL, if present, in SIB1, SIB2 and SIB4, |
| | additionally, if QrxlevminoffsetcellSUL is present in SIB3 and |
| | SIB4 for the concerned cell, this cell specific offset is added to |
| | the corresponding Qrxlevmin to achieve the required |
| | minimum RX level in the concerned cell; |
| | else Qrxlevmin is obtained from q-RxLevMin in SIB1, SIB2 and |
| | SIB4, additionally, if Qrxlevminoffsetcell is present in SIB3 and |
| | SIB4 for the concerned cell, this cell specific offset is added to |
| | the corresponding Qrxlevmin to achieve the required |
| | minimum RX level in the concerned cell. |
| Qqualmin | Minimum required quality level in the cell (dB). Additionally, if |
| | Qqualminoffsetcell is signaled for the concerned cell, this cell |
| | specific offset is added to achieve the required minimum |
| | quality level in the concerned cell. |
| Qrxlevminoffset | Offset to the signaled Qrxlevmin taken into account in the |
| | Srxlev evaluation as a result of a periodic search for a higher |
| | priority PLMN while camped normally in a VPLMN, as |
| | specified in TS 23.122. |
| Qqualminoffset | Offset to the signaled Qqualmin taken into account in the |
| | Squal evaluation as a result of a periodic search for a higher |
| | priority PLMN while camped normally in a VPLMN, as |
| | specified in TS 23.122. |
| Pcompensation | For FR1, if the UE supports the additionalPmax in the NR-NS- |
| | PmaxList, if present, in SIB1, SIB2 and SIB4: |
| | max(PEMAX1-PPowerClass, 0)-(min(PEMAX2, PPowerClass)- |
| | min(PEMAX1, PPowerClass)) (dB); |
| | else: |
| | max(PEMAX1-PPowerClass, 0) (dB) |
| | For FR2, Pcompensation is set to 0. |
| | For IAB-MT, Pcompensation is set to 0. |
| PEMAX1, PEMAX2 | Maximum TX power level of a UE may use when transmitting |
| | on the uplink in the cell (dBm) defined as PEMAX in TS 38.101. |
| | If UE supports SUL frequency for this cell, PEMAX1 and |
| | PEMAX2 are obtained from the p-Max for SUL in SIB1 and NR- |
| | NS-PmaxList for SUL respectively in SIB1, SIB2 and SIB4 as |
| | specified in TS 38.331, else PEMAX1 and PEMAX2 are |
| | obtained from the p-Max and NR-NS-PmaxList respectively in |
| | SIB1, SIB2 and SIB4 for normal UL as specified in TS 38.331. |
| PPowerClass | Maximum RF output power of the UE (dBm) according to the |
| | UE power class as defined in TS 38.101-1. |

The signaled values Qrxlevminoffset and Qqualminoffset may only be applied when a cell is evaluated for cell selection as a result of a periodic search for a higher priority PLMN while camped normally in a VPLMN. During this periodic search for higher priority PLMN, the WTRU may check the S criteria of a cell using parameter values stored from a different cell of this higher priority PLMN.

A WTRU in RRC_IDLE/RRC_INACTIVE performs cell reselection at 530, 550, for example. The WTRU can perform intra-frequency, inter-frequency or inter-RAT cell re-selection. The WTRU is configured with priorities among RATs (e.g., prioritize camping on NR over LTE whenever an NR cell is available) or among frequencies within the same RAT (e.g., fa has highest priority, fb has medium priority, fc has lowest priority, etc.,). A neighbor cell list (NCL) may be provided to the WTRU, indicating which neighbor cells (e.g., intra-frequency, inter-frequency, inter-RAT) shall be considered for cell reselection. Allow-lists may be provided to the WTRU, indicating the only neighboring cells that could be considered for re-selection. Exclude-lists may be provided to the WTRU, indicating the neighboring cells that should not be considered for re-selection. The WTRU may attempt to camp on a cell operating with the highest priority RAT and with the highest priority frequency. If the serving cell fulfils Srxlev>SIntraSearchP and Squal>SintraSearchQ, the WTRU may choose not to perform intra-frequency measurements, otherwise, the WTRU may perform intra-frequency measurements.

If the serving cell fulfils Srxlev>SnonIntraSearchP and Squal>SnonIntraSearchQ, the WTRU may choose not to perform measurements of NR inter-frequency cells of equal or lower priority, or inter-RAT frequency cells of lower priority, otherwise, the WTRU may perform measurements of NR inter-frequency cells of equal or lower priority, or inter-RAT frequency cells of lower priority.

SIntraSearchP specifies the Srxlev threshold (in dB) for intra-frequency measurements. SIntraSearchQ specifies the Squal threshold (in dB) for intra-frequency measurements. SnonIntraSearchP specifies the Srxlev threshold (in dB) for NR inter-frequency and inter-RAT measurements. SnonIntraSearchQ specifies the Squal threshold (in dB) for NR inter-frequency and inter-RAT measurements.

When the WTRU decides to perform intra-frequency measurements for cell re-selection based on the criteria above, the WTRU may perform the cell rankings of the concerned cells. Inter-frequency and inter-RAT reselection is based on absolute priorities where a WTRU tries to camp on the highest priority frequency available. The cell-ranking criterion (referred to as Criteria R) for serving cell (Rs) and for neighboring cells (Rn) is defined by Eq. 2 and Eq. 3.

Rs=Qmeas,s+Qhyst−Qoffsettemp Eq. 2

Rn=Qmeas,n−Qoffset−Qoffsettemp Eq. 3

where:

| Qmeas | RSRP measurement quantity used in cell reselections. |
|---|---|
| Qoffset | For intra-frequency: Equals to Qoffsets,n, if Qoffsets,n is |
| | valid, otherwise this equals to zero. |
| | For inter-frequency: Equals to Qoffsets,n plus |
| | Qoffsetfrequency, if Qoffsets,n is valid, otherwise this |
| | equals to Qoffsetfrequency. |
| Qoffsettemp | Offset temporarily applied to a cell as specified in TS |
| | 38.331. |

The WTRU may perform ranking of all cells that fulfil the cell selection criterion S defined above. The cells may be ranked according to the R criteria specified above by deriving Qmeas,n and Qmeas,s and calculating the R values using averaged RSRP results. If range ToBestCell is not configured, the WTRU may perform cell reselection to the highest ranked cell. If rangeToBestCell is configured, then the WTRU may perform cell reselection to the cell with the highest number of beams above the threshold (i.e. absThreshSS-BlocksConsolidation) among the cells whose R value is within rangeToBestCell of the R value of the highest ranked cell. If there are multiple such cells, the WTRU may perform cell reselection to the highest ranked cell among them.

The WTRU may reselect the new cell at 525, only if certain conditions are met. Such conditions include the new cell is better than the serving cell according to the cell reselection criteria specified above during a time interval TreselectionRAT, and more than 1 second has elapsed since the WTRU camped on the current serving cell.

The WTRU may use measurement gaps to perform measurements when it cannot measure the target carrier frequency while simultaneously transmitting/receiving on the serving cell. In the case of LTE, the WTRU needs measurement gaps to perform inter-frequency and inter-RAT measurements. Typical LTE gap length is 6 ms which accommodates 5 ms measurement time (PSS and SSS are transmitted once every 5 ms) and RF re-tuning time of 0.5 ms before and after the measurement gap. The measurement gap repeats with a periodicity of either 40 ms or 80 ms. Similarly, in NR, the measurements that the WTRU performs can be gap-assisted (network configures measurement gap) or non-gap-assisted. The use of measurement gap in NR depends on the capability of the WTRU, the active BWP of the WTRU and the current operating frequency. In NR, measurements gaps might be required for intra-frequency, inter-frequency and inter-RAT measurements. Unlike LTE intra-frequency case, intra-frequency measurements in NR might require a measurement gap in cases for example, if the intra-frequency measurements are to be done outside of the active BWP. Measurement gap lengths of 1.5, 3, 3.5, 4, 5.5, and 6 ms with measurement gap repetition periodicities of 20, 40, 80, and 160 ms are defined in NR.

In NR, the RF re-tuning time is 0.5 ms for carrier frequency measurements in FR1 (Frequency Range 1) and 0.25 ms for FR2 (Frequency Range 2), where FR1 defines bands in the sub-6 GHz spectrum and FR2 defines bands in the mmWave (millimeter wave) spectrum. For example, a gap length of 4 ms for FR1 measurements would allow 3 ms for actual measurements and a gap length of 3.5 ms for FR2 measurements would allow 3 ms for actual measurements. During the measurement gaps, the measurements are to be performed on SSBs of the neighbor cells. The network provides the timing of neighbor cell SSBs using SS/PBCH Block Measurement Timing Configuration (SMTC).

The measurement gap and SMTC duration are configured such that the WTRU can identify and measure the SSBs within the SMTC window i.e., the SMTC duration should be sufficient enough to accommodate all SSBs that are being transmitted.

For SSB based intra-frequency measurements, the network may configure measurement gaps if any of the WTRU configured BWPs do not contain the frequency domain resources of the SSB associated to the initial DL BWP.

For SSB based inter-frequency measurements, the network may configure measurement gaps if the WTRU supports per-FR measurement gaps and if the carrier frequency to be measured is in same FR as any of the serving cells. For SSB based inter-frequency measurements, the network may configure measurement gaps if the WTRU only supports per-WTRU measurement gaps. In this case, the measurement object can be configured on any frequency range (FR1 or FR2) but the gap may be configured by the network.

Inter-RAT measurements in NR are limited to E-UTRA. For a WTRU configured with E-UTRA Inter-RAT measurements, a measurement gap configuration may be provided when the WTRU only supports per-WTRU measurement gaps; or the WTRU supports per-FR measurement gaps and at least one of the NR serving cells is in FR1. Depending on the WTRU capability to support independent FR measurement and network preference, there are two types of measurement gaps defined in NR; per-WTRU and per-FR. In per-FR gap, two independent gap patterns (i.e., FR1 gap and FR2 gap) are defined for FR1 and FR2 respectively. Per-WTRU gap applies to both FR1 (E-UTRA and NR) and FR2 (NR) frequencies.

The main parameters of a measurement gap configuration include mgrp (Measurement Gap Repetition Period) is the periodicity (in ms) at which measurement gap repeats. Periodicities of 20, 40, 80, and 160 ms are defined in NR.

The main parameters of a measurement gap configuration include gapOffset is the gap offset of the gap pattern. Not all 160 offset values applicable for all periodicities. As the offset values points to the starting subframe within the period, its value range is from 0 to mgrp-1. For example, if the periodicity is 40 ms, the offset ranges from 0 to 39.

The main parameters of a measurement gap configuration include mgl (Measurement Gap Length) is the length of measurement gap in ms. Measurement gap lengths of 1.5, 3, 3.5, 4, 5.5, and 6 ms are defined in NR.

The main parameters of a measurement gap configuration include mgta (Measurement Gap Timing Advance). If this is configured, the WTRU starts the measurement mgta ms before the gap subframe occurrence i.e., the measurement gap starts at time mgta ms advanced to the end of the latest subframe occurring immediately before the measurement gap. The amount of timing advance can be 0.25 ms (FR2) or 0.5 ms (FR1).

The WTRU may be configured with several measurement gap configurations.

Network energy consumption can be significant and, in some cases, unnecessary, e.g., during quiet hours. The network may turn off small cells and rely on macro-cells for coverage during quiet hours, turn off some sectors or gNBs altogether, reduce the PA power consumption, and/or enable a gNB-side sleep pattern without sacrificing WTRU performance considerably. gNBs combine info including WTRU measurements, WTRU assistance info, interference status, load information, proprietary info to make this decision.

From the WTRU perspective, WTRU may experience a coverage loss when the capacity of some cells are activated NES and the WTRU may not be aware that the gNB is NES state (e.g., deep sleep or dormant) especially in IDLE and INACTIVE states. Adapting network availability resources needs to accommodate how the WTRU knows whether common cell signals (e.g., SSBs, paging, SI) are transmitted as usual or not, as opposed to not receiving them due to bad channel conditions.

Some WTRU control-plane procedures for connectivity management, WTRU reachability, cell re-selection, and WTRU battery consumption may be impacted when gNBs sleep or turn off, including Inter-cell Mobility and re-selection and WTRU measurements.

For Inter-cell Mobility and re-selection, when a gNB turns off or goes to dormant or deep sleep state, the network may want to offload/handover remaining WTRUs to other cells in the area. Executing handover commands/RRC reconfiguration for each of the remaining WTRUs requires multiple signaling and can delay the time the gNB goes to sleep. For Idle mode WTRUs, the network is not aware of which WTRUs are camped on it. One problem is how to select a CHO candidate for mobility when the serving cell turns off/sleeps, especially when some candidate cells may be in sleep mode, may support both legacy and NES capable WTRUs, and/or may be more appropriate for a subset of services (e.g., eMBB or IoT). Furthermore, the WTRU may proactively start inter-cell/inter-frequency measurements on neighboring cells before a serving cell turning off or goes to sleep or when an NES cell turns on.

For WTRU measurements, when the network changes it's sleep states, some measurement resources for mobility or cell reselection may not be applicable. Given sleep states and gNB on/off status changes dynamically, relying on existing framework mandates the network to dynamically issue RRC reconfiguration messages for each WTRU in the cell each time the gNB goes into sleep or turns off, which incurs a lot of overhead and may also delay the gNB sleep start time.

The terms “energy saving mode”, “NES state”, “availability state”, “power saving mode”, “Cell DTX state/mode” and “sleep mode” are used interchangeably. When a cell is in full power operation, it can be considered to have no NES state, or it has a “normal mode” or “full power operation” NES state. The NES state change can be indicated to the WTRU either directly (e.g., group DCI, broadcast message, etc.,) or implicitly (e.g., WTRU noticing a change in the SSB pattern, etc.,).

The WTRU may consider an NES state as Cell DTX or Cell DRX activated, and another NES state where Cell DTX and/or Cell DRX de-activated. The WTRU may consider an NES state during active periods of an active Cell DTX/DRX, while the WTRU may consider another NES state during inactive periods of an active Cell DTX and/or DRX configuration. The WTRU may consider a separate NES state for each Cell DTX and/or cell DRX configurations.

Cell DTX active period may correspond to the WTRU's C-DRX On Duration or Active Time, while cell DTX inactive periods may correspond to the WTRU's C-DRX Inactive Time. The WTRU may consider one NES state when a subset of spatial elements (e.g. number of ports, number of elements) is activated or deactivated, vs. another NES state when a different subset of spatial elements in activated or deactivated. The WTRU may consider one NES state when a PDSCH power is reduced (e.g., the WTRU is indicated with a different PDSCH to CSI-RS power offset) vs. another NES state when the PA is operating per legacy assumptions or without PDSCH power reduction. The WTRU may consider a cell in NES state when the PA power is reduced (for all or a subset of channels), if power is boost is changed for a subset of channels, and/or if the PA is operating a low efficiency state (e.g. in a configuration corresponding to a lower input bias current).

Cell DTX inactive period: duration of time over which a configured cell DTX pattern is not active/inactive (e.g., periods of time outside periodic On Duration periods of a Cell DTX pattern). This may be applicable only after a cell DTX configuration has been indicated by the NW to be activated. Activated Cell DRX/DTX: A state of a configured cell DRX or Cell DTX pattern, where such state has been activated by L1/L2 DL signalling, RRC (re)-configuration, and/or cell common configurations, and has not been de-activated.

For connected mode, the WTRU may start mobility related measurements (e.g., channel conditions, interference measurement resource (IMR) or CHO related measurements) including inter-cell, inter-frequency, and/or inter-RAT measurements following reception of a NES state change signaling or determining an NES state change on the serving cell or a cell DTX indication relating to the serving cell or a neighboring cell, e.g., at an instance between 0 and t1. the WTRU may start mobility related measurements (e.g., channel conditions or CHO related measurements) including inter-cell, inter-frequency, and/or inter-RAT measurements following meeting at least of the conditions listed above for NES specific CHO conditions and selection, e.g., serving cell changing its NES state, serving cell activating cell DTX, neighboring cell changing its NES state, neighboring cell activating DTX, as a function of the serving cell going into an active period/On duration of its configured cell DTX pattern, and/or as a function of the neighboring cell going into an active period/On duration of its configured cell DTX pattern). For a neighboring cell, the UE may start related inter-cell measurement during the neighboring cell's cell DTX On duration if the neighbor cell DTX pattern configuration is provided by the serving cell. The WTRU may initiate such measurements even before the reception or determination of an NES state change of the serving cell possibly triggered by reception of an indication or signaling from the NW (e.g., group common L1/L2 signaling (e.g., for cell DTX), broadcast signaling or configuration, or an RRC reconfiguration message), and the WTRU may start a timer following the reception of such indication to perform the measurements within a configured or predetermined time window (t2). The WTRU may report measurements between prior to the expiry of t2. This can enable the gNB with whether it changes into sleep or deep sleep or off, and/or by how much it may reduce its PA power efficiency, and also enables the gNB to transition into an NES state at different times (non-static) after the WTRU starts performing and reporting measurements.

The WTRU may measure candidate cells selected per the methods described herein for NES specific CHO conditions and selection, cells configured as alternate cells, cells in the same DU, cells in the same site, cells with known cell DTX configuration or cells serving only NES-capable WTRUs.

A WTRU in CONNECTED state may be configured with different s-measure configurations for different NES states of the serving cell, e.g., depending whether the cell has Cell DTX activated or not. For example, the WTRU may be configured with a set of s-measure configurations, each associated with one or more NES states. For example, when the WTRU may apply the following s-measure thresholds: RSRP_threshold_1: NES state 1, normal mode (e.g., On or active downlink and/or uplink); RSRP_threshold_2: NES state 2, micro sleep mode; RSRP_threshold_3: NES state 3, light sleep mode; RSRP_threshold_4: NES state 4, deep sleep mode; RSRP threshold 5: NES state 5, reduced power or PA efficient state; etc., where RSRP_threshold_1<RSRP_threshold_2<RSRP_threshold_3<RSRP_threshold_4, etc. That is, the deeper the sleep mode, the WTRU may be performing more aggressive measurements for alternative cells (i.e., even when the serving cell's conditions, from signal level point of view, are excellent).

Instead of different S-measure thresholds for each NES state, the WTRU may be configured with one S-measure threshold (as in legacy), to be applied when the serving cell is in full power mode, but configured with a scaling factor or an offset to apply for each NES state, and the WTRU updates the S-measure value according to the scaling factor or offset and the current NES state whenever the NES state of the serving cell changes. The scaling factor may be provided via dedicated signaling (e.g., as part of the S-measureConfig) or it can be provided via a broadcast signaling (e.g., the same scaling factor applicable to the WTRUs in that cell).

The S-measure configuration may be dependent on the direction of the NES state transition. For example, a certain S-measure is applicable when the NES state changes from NES state 1 to NES state 3, and another S-measure configuration is applicable when the NES state changes from NES state 2 to NES state 3, etc.

The S-measure configuration may be extended to cover different types of neighbor cells. For example, different S-measures (or scaling factors) can be configured for different types of measurements (e.g., one set of S-measures related to starting intra-frequency measurements, one set of S-measures related to starting inter-frequency measurements, one set of S-measures related to starting inter-RAT measurements, etc.), and these S-measure configurations could be associated with an NES state. For example, the WTRU may receive an S-measure configuration for intra-frequency measurements and another S-measure for inter-frequency measurements, where each S-measure configuration could also have different thresholds for different NES states.

The WTRU may be configured with different measurement gap configurations to be applied for intra-frequency, inter-frequency or/and inter-RAT measurements that are dependent on the NES state of the serving cell. For example, the WTRU may measure or skip a measurement occasion of a given cell depending on the cell's cell DTX activity, where the WTRU may make measurements on measurement occasions overlapping with the cell's cell DTX active period/on duration. Measurements may include L1, L2, and/or L3 measurements.

Each measurement gap configuration may be associated with one or more NES states (e.g., whether the cell has Cell DTX active or not) of the serving cell or/and target cells (e.g., an IE in the measurement gap configuration that specifies the NES state or states that the measurement gap is to be applied, an IE in the measurement gap configuration that specifies the NES state or states the measurement gap configuration is not to be applied, etc.). For example, if a measurement gap configuration indicates that it is to be applied in light sleep, the WTRU may not apply that measurement gap and perform the associated intra/inter-frequency or inter-RAT measurements until it determines the serving cell has started operating in light sleep mode). In another example, if a measurement gap configuration associated with a cell indicates that it is to be applied during sleep/cell DTX active mode, the WTRU may not apply that measurement gap and perform the associated intra/inter-frequency or inter-RAT measurements until it determines the cell has activated Cell DTX (whether the cell is a serving cell or a neighboring cell) and the cell is transmitting related measurement signals during the measurement gap (e.g. during the cell DTX on duration of the associated cell).

Instead of configuring different measurement gap configuration for different NES states, the WTRU may be configured with a baseline configuration that is applicable when the serving cell is operating in full power mode, and scaling factor, offsets, or factors can be configured that are associated with different NES state or cell DTX, and the WTRU may apply these scaling factors on top of the baseline measurement gap configuration. For example, the WTRU may be configured to apply a scaling factor on the measurement gap length or measurement gap repetition period depending on the NES state (the scaling factor can be the same for the measurement gap length and repetition period for a given NES state, or a different scaling factor can be provided per each parameter per each NES state).

The scaling factor(s) may be specified at a given measurement gap configuration level. The scaling factor(s) may be specified to be applicable (common) to all measurement gap configurations. The scaling factor(s) may be specified to be applicable (common) to a sub set of the WTRU's measurement gap configurations (e.g., only for FR1 gaps, only for FR2 gaps, only for per WTRU gaps, only for an explicitly configured list of the measurement gap configurations). The scaling factor may be provided via dedicated signaling (e.g., as part of the MeasConfig) or it can be provided via a broadcast signaling (e.g., the same scaling factor applicable to the WTRUs in that cell).

The measurement gap configuration may be dependent on the direction of the NES state transition. For example, a certain measurement gap configuration is applicable when the NES state changes from NES state 1 to NES state 3, and another measurement gap configuration is applicable when the NES state changes from NES state 2 to NES state 3, etc. For example, a certain measurement gap configuration is applicable when the cell DTX mode changes from active to inactive, a certain measurement gap configuration is applicable when the cell DTX is (de)-activated, and another measurement gap configuration is applicable when cell DTX mode changes from inactive to active. A cell DTX mode configuration may be associated with one or more measurement gap configuration.

The WTRU may be configured to keep applying a certain measurement gap configuration (or a measurement gap configuration scaled/updated according to the change of the NES state) as long as the NES state returns to the state before which the measurement gap became active. For example, if the measurement gap configuration became active on the NES state change from light sleep to medium sleep, the WTRU may keep using that measurement gap when the NES state of the serving cell changes from medium sleep to deep sleep, or back to medium sleep again, but may stop using that measurement gap when the NES state changes back to light sleep mode again. In another example, if the measurement gap configuration became active based on the activation of Cell DTX, the WTRU may stop using that measurement gap when Cell DTX is deactivated.

The WTRU may be configured with different measurement object configurations that are associated with one or more of the NES states or cell DTX configuration of the serving cell and/or neighbor cells. For example, an IE can be introduced in the measObjectNR or in the measObjectToAddModList IEs that indicates to which NES state(s) that the measurement object is relevant to or associated with. In another example, the IE could indicate to which NES state(s) that the measurement object is not relevant to, e.g., whether the measurement configuration is applicable in cell DTX or for a specific cell DTX configuration. In another example, an IE can be introduced (e.g., in the MeasConfig) that indicates the mapping/association between measurement objects and NES states (e.g., NES state 1: measobject ID1, measobject ID2; NES state 2: measobject ID1, measobject ID3, etc.). The WTRU may determine such configuration in the HO command and/or configured part of CHO candidate list (e.g., whereby the source cell provides the cell DTX and/or cell DRX configuration(s) associated with the target cell). The WTRU may receive a configuration from the source cell of cell DTX patterns associated with neighboring cells such that it knows when to perform mobility and RRM measurements on neighboring cells.

The WTRU may be configured with different measurement reporting/event configurations that are associated with one or more of the NES states of the serving cell and/or neighbor cells. For example, an IE can be introduced in the reportConfigNR or the reportConfigToAddModList IE that indicates to which NES state(s) that the measurement reporting/event configuration is relevant to or associated with. In another example, the IE could indicate to which NES state(s) that the measurement reporting/event configuration is not relevant to. In another example, an IE can be introduced (e.g., in the MeasConfig) that indicates the mapping/association between measurement reporting/event configuration and NES states (e.g., NES state 1: reportConfig ID1, reportConfig ID2; NES state 2: reportConfig ID1, reportConfig ID3, etc.).

The WTRU may be configured with different measurement ID configurations that are associated with one or more of the NES states of the serving cell and/or neighbor cells. For example, an IE can be introduced in the measIDToAddMod IE that indicates to which NES state(s) that the measurement ID configuration is relevant to or associated with. In another example, the IE could indicate to which NES state(s) that the measurement ID configuration is not relevant to. In another example, an IE can be introduced (e.g., in the MeasConfig) that indicates the mapping/association between measurement IDs and NES states (e.g., NES state 1: meas ID1, meas ID2; NES state 2: meas ID1, meas ID3, etc.).

In one example, the WTRU may deactivate a measurement object, measurement reporting, measurement resource, or meas ID configuration when the NES state changes to a state that is not associated with the measurement object, measurement reporting or meas ID.

For example, when the NES state changes to a state that a given measID is not associated with, the WTRU may stop performing measurements at the frequency/RAT the measurement object that is associated with this measurement ID.

Further, for example, when the NES state changes to a state that a given reportConfig is not associated with, the WTRU may stop monitoring the conditions for triggering measurement reporting or CHO execution as specified in this reporting configuration (for any measurement object associated with this reporting configuration in a measurement ID), but it may still keep performing the measurements (as long as the associated measID and/or measObject are associated with the current NES state), when Cell DTX is activated and the measID is associated with cell DTX, the WTRU may start performing measurements at the frequency/RAT the measurement object that is associated with this measurement ID. When Cell DTX is deactivated, the UE may stop performing such measurements, when Cell DTX is activated and the measID is not associated with inactive periods of cell DTX, the WTRU may stop performing measurements at the frequency/RAT the measurement object that is associated with this measurement ID during cell DTX inactive periods (e.g. outside of cell DTX on durations).

In one example, the WTRU may activate a deactivated measurement object, measurement reporting, or meas ID configuration when the NES state changes to a state that is associated with the measurement object, measurement reporting or meas ID. For example when the NES state changes to a state that a given measID is associated with, the WTRU may start performing measurements at the frequency/RAT the measurement object that is associated with this measurement ID. If the reportConfig associated with this measID is also associated with the current NES sate, the WTRU may start monitoring the measurement reporting or CHO triggering conditions indicated in the reportConfig

The WTRU may be configured to release all measurement results associated with a given measID and/or measObject configurate when the measID and/or measObject is deactivated. For example, the WTRU may be configured to release all measurement results associated with a given measID and/or measObject configurate when the NES state is reconfigured (e.g. when cell DTX is reconfigured).

The WTRU may be configured to keep all measurement results associated with a given measID and/or measObject configurate when the measID and/or measObject is deactivated.

It should be noted that the maximum number of measurement objects, measurement reporting and ID configurations that a WTRU may be configured with is currently limited. Specifically, maxNrofObjectId=64, maxReportConfigId=64, and maxNrofMeasId=64. Additionally, WTRU capability may further limit these maximum values. For example, a low capability WTRU may be able to perform only 8 measurements at once (i.e., maxNrofMeasID=8).

Using the included method of associating measurement objects, reporting and ID configurations with NES states above, allow for configuring the WTRU with more than the ones allowed in the specification (and the WTRU is capable of), because not all of them are active/relevant for a given NES sate of the serving cell, and the serving cell can be only in one NES state at a given time. The concepts discussed above could be generalized even to sub elements of a given measurement object configuration. For example, the quantity configuration that is associated with a given measurement object (that includes information such as the L3 filtering coefficients) may be configured to be dependent on the NES state (e.g., a given measurement object configured with multiple quantity configurations, where each configuration is associated with a given NES sate, and the WTRU applying the configuration that is associated with the current NES state of the serving cell).

The NES state change indication received by the WTRU may include time information (e.g., NES state to change to medium sleep within x ms, Cell DTX activation time, DTX ON duration to start periodically, etc.) In such a case, the WTRU may perform the update of the s-measure, measurement object, measurement reporting, measurement ID, and/or measurement gap, using any of the solutions discussed above in one or more of the following ways. The WTRU may perform immediately on the reception of the NES state change indication. The WTRU may perform when the NES state change becomes effective (e.g., timer expires that was started with a value equal to the indicated anticipated NES state change, during ON durations of a cell DTX pattern, etc.). The WTRU may perform any time between the reception of the indication of the NES state change (or anticipated change) and when the NES state change actually takes effect. The WTRU may decide to apply immediately or when the NES change becomes effective, depending on the current and upcoming NES state change. For example, if the NES state is changing from full operational mode to light sleep, the WTRU may wait until the indicated time of NES state change to perform the update of any of the relevant measurement configuration, while if the NES state is changing from light sleep mode to deep sleep (or to be turned off completely), the WTRU may perform all the relevant measurement configuration updates immediately without waiting until the NES state change takes effect. The WTRU may perform depending on current WTRU conditions such as battery level, UL buffer level, UL/DL data rate, active bearer/traffic type, etc., (e.g., immediately apply the updates if the UL buffer level is above a certain threshold but wait until the NES state change takes effect if the UL buffer level is below a certain threshold).

The WTRU may send an indication to the network regarding its change of behavior related to any of the changes related to measurement configurations discussed above (e.g., S-measure update, measurement gap update, activation/deactivation of a measurement object, reporting configuration or measurement ID, etc.). This indication may be sent when it has updated the configuration. This indication may be sent when it starts performing neighbor measurements due to the updated configuration (e.g., due to an S-measure change, due to the activation of a measurement ID, due to the application of a measurement gap, etc.,). This indication may be sent when measurement reports are triggered afterwards/due to the configuration change. This indication may be sent when CHO is executed afterwards/due to the configuration change. The WTRU may not send an indication to the network regarding such change of behavior related to any of the measurement related configurations discussed above immediately, but keep it stored in log/information. The WTRU may indicate, for example, in a WTRU Assistance Information message, in NES assistance information message, in an RRC Reconfiguration Complete message, HO complete message, etc.,) that it has such information available. The network can request the information at any time, or as a response to an indication from the WTRU that the information is available. The WTRU may also send the indication opportunistically via another message (e.g., in a HO complete message, in a Reconfiguration complete message, etc.).

Other measurements in connected BFD/RLM/RRM/CSI may also be performed.

The WTRU may be configured with different mobility or cell re-selection measurement resources per NES state, including measurement objects, IDs, gaps, reporting configs, and/or quantity configs. The WTRU may apply the set of measurement configurations/resources according to the NES state associated with the source cell, target cell, camped cell, the candidate cell to reselect to, and/or the frequency layer to reselect to.

The relaxation of BFD/RLM/RRM or CSI measurements during cell DTX inactivity periods or NES state may occur. The WTRU may suspend L1/L2/L3 measurement occasions while cell DTX and/or cell DRX is activated. The WTRU may relax BFD, RLM, RRM, CSI, IMR measurements when cell DTX is active. The WTRU may suspend CSI measurements and beam management during cell DTX inactive period, e.g. if SSBs or RS are not transmitted per legacy assumptions.

The WTRU may maintain one or more sets of minimum requirements of CSI-RS and/or SSB based beam failure detection for WTRU fulfilling relaxed measurement criteria if cell DTX is activated and/or during the cell DTX inactive period. The WTRU may maintain one or more sets of minimum requirements of CSI-RS and/or SSB based radio link monitoring for WTRU fulfilling relaxed measurement criteria if cell DTX is activated and/or during the cell DTX inactive period. The WTRU may be configured with an alternative T_{DRX} period for measurements to apply when a cell DTX configuration is activated in the serving cell. If a cell DTX configuration is activated, the UE may replace T_{CSI-RS} with max (cell DTX periodicity, T_{CSI-RS}) when performing BFD/RLM/RRM/CSI measurements.

L1 measurements in anticipation of an SSB-less inter-band SCell activation may occur. In one deployment scenario, the WTRU may be configured per SCell with one or more CSI-RS configuration per SSB-less SCell associated with SSBs transmitted on the PCell or another anchor SCell. The WTRU may start performing measurements on such CSI-RS resources upon—or prior to—reception of an SCell activation command, and/or synchronizing to SSBs transmitted on the PCell or another anchor SCell. The WTRU may adjust the time-frequency synchronization determined from SSB measurement on the PCell by applying a frequency or a time shift as a function of the measured CSI-RS from the SSB-less SCell.

In case of an SSB-less Scell configuration, followed by an immediate Scell activation command, the WTRU may assume that the CSI-RS broadcasted on Scell for further measurements are QCL-ed with the SSBs on the Pcell or PScell on its designated CG (Cell Group) and thus the same spatial filter can be applied to the Scell reception. As the full activation of the Scell is acquired only after a valid (in range) CQI is delivered to the network, meaning Scell PDCCH reception and decoding ready, the network may speed up the process sending a CSI-RS aperiodic measurement request on the Pcell DCI for a cross cell measurement, that may be sent on the PUCCH or PUSCH UCI on the Pcell UL. After the full Scell activation, and first CSI-RS feedback from the Scell, or alternatively after the first PDCCH decoded on the Scell, the WTRU may follow its CSI-RS configured measurements on the new carrier aggregation state.

In a carrier aggregation scenario, when the WTRU is configured with an SSB-less Scell, the WTRU beam management on the Scell may be based exclusively on CSI-RS. As the inter-band case has different propagation properties between bands, the beam width may be different and the pathloss as well. Thus, even though the Pcell and Scell may be quasi-collocated, the RLM and RLF on Scell may have different behaviors.

If a beam failure is declared on the Scell, while the Pcell is still in synchronous and functional state, the beam failure message may be sent on the Pcell. One of the issues is how to replace a beam in the situation where no SSBs are Scell.

In one solution, a conditional beam change procedure may be applied. The network may preconfigured beams in this SSB-less cell for the WTRU, for example adjacent beams with the active beam, that may be activated upon a first beam failure on Scell by the WTRU, and associated CSI-RS measurement on a secondary group of beams.

Alternatively, an SSB-less Scell that has a preconfigured conditional beam change procedure, the beam change mechanism may be associated with an CSI-RS measurement threshold, that may trigger a report from the WTRU before an RLF on Scell SSB-less beam occurs. The preconfigured beam change set may have their own CSI-RS configurations that the WTRU may measure. The WTRU report triggering measurement threshold may be an absolute RSRP level of the serving beam going below a certain quality, or a relative delta between the active beam and the prepared beam candidates on Scell in favor of a candidate beam.

Upon the WTRU report triggered by a beam change procedure, the WTRU may start scanning the PDCCH of the candidates beams along with the active PDCCH. The first detected correct PDCCH addressed to the WTRU on a candidate beam may mark the conditional beam change success.

The WTRU may be configured with different measurement object configurations that are associated with when a serving cell is operating with DRS and/or SSBs with longer periodicity.

L1 measurements in triggered by spatial adaptation may occur. The WTRU may be configured with different measurement object configurations that are associated with one or more of the NES states or spatial element activation state of the serving cell and/or neighbor cells. For example, a measurement resource configuration may indicate which spatial element configuration that the measurement object is relevant to or associated with. Upon determination or reception of an indication indicating a change in the number of active spatial elements, the WTRU may change the measurement configuration to match the spatial element activation state of the serving cell.

L1 measurements in triggered by PA power reduction or CSI RS power boost change may occur.

The WTRU may be configured to measure and/or report CSI measurements) e.g. multiple CSI reports in a single report) to reflect different PA configurations, power offsets, number of active spatial elements and/or gNB transmit power configurations.

The WTRU may be configured with multiple CSI reporting configurations, the WTRU may select appropriate configuration for PUCCH reporting based on report payload size and/or the number of CSI reports combined together.

The WTRU may add an offset to the masked pathloss, CSI-RS measurement, and/or PRS measurements- or estimate pathloss/measurements differently—of the serving cell (e.g. during the PHR or RACH procedures) if the serving cell has a certain NES state activated (e.g. cell DTX, reduced number of spatial elements, reduced PA power, changed CSI-RS to PDSCH power offset), where the offset may depend on the NES state. The WTRU may apply such offset and/or change the pathloss estimation depending on whether the DL power is reduced for all DL channels/signals or just a subset (e.g. for data channels only). The WTRU may apply such offset and/or change the pathloss estimation if the CSI-RS power boost (with respect to other data channels) is changed from a default configured value for legacy WTRUs. The WTRU may apply such offset to neighboring cells for mobility or RRM measurements, possibly if an indication on NES state configurations is provided by the source cell.

Measurements in IDLE/Inactive modes may occur. For example, these measurements may include mobility measurements for cell selection or re-selection in IDLE/INACTIVE state. In IDLE/INACTIVE state, the WTRU may be configured to change its cell selection (S-Criteria) for cell selection (as described above) that is dependent on the NES state of the concerned cell. For example, the WTRU may be configured with different parameter/offset values for calculating the Srexlev and/or Squal of the concerned cell for different NES state of the concerned cell (e.g., different set of values for Qrxlevmin, Qqualmin, Qrxlevminoffset, Qqualminoffset, and/or Qoffsettemp for different NES state of the concerned cell for which the S-Criteria is being evaluated for cell selection). Alternatively, the WTRU may be configured with one set of values for cell selection parameters for normal mode (i.e., no power saving), and scaling factors to be applied to these values for each NES state. The scaling factor may be the same for each value for a given NES state, or different scaling factor can be configured for each cell selection related parameter.

In IDLE/INACTIVE state, WTRU may be configured to change its criteria for starting intra-frequency measurements for cell re-selection (as described above) that is dependent on the NES state of the serving cell. For example, the WTRU may be configured with different SIntraSearchP and/or SIntraSearchQ values for each NES state. Alternatively, the WTRU may be configured with one pair of SIntraSearchP/SIntraSearchQ values for normal mode (i.e., no power saving), and scaling factors to be applied to these values for each NES state. The scaling factor may be the same for both SIntraSearchP and SintraSearchQ, or different scaling factor can be configured for SIntraSearchP and SIntraSearchQ.

In IDLE/INACTIVE state, WTRU may be configured to change its criteria for starting inter-frequency or inter-RAT measurements for cell re-selection (as described above) that is dependent on the NES state of the serving cell. For example, the WTRU may be configured with different SnonIntraSearchP and/or SnonIntraSearchQ values for each NES state. Alternatively, the WTRU may be configured with one pair of SnonIntraSearchP/SnonIntraSearchQ values for normal mode (i.e., no power saving), and scaling factors to be applied to these values for each NES state. The scaling factor may be the same for both SnonIntraSearchP and SnonIntraSearchQ, or different scaling factor can be configured for SnonIntraSearchP and SnonIntraSearchQ.

In IDLE/INACTIVE state, the WTRU may be configured to change its cell ranking (Criteria R) for cell re-selection (as described above) that is dependent on the NES state of the serving and/or neighbor cell. For example, the WTRU may be configured with different values of Qhyst for different NES states of the serving cell. For example, the WTRU may be configured with different values of Qoffset for different NES states of a neighbor cell. Alternatively, the WTRU may be configured with one Qhyst value for normal mode (i.e., no power saving in the serving cell), and scaling factors to be applied to this value for each NES state of the serving cell. Similarly, the WTRU may be configured with one Qoffset value for normal mode (i.e., no power saving in the concerned neighbor cell), and scaling factors to be applied to this value for each NES state of the neighbor cell. The scaling factor may be the same for Qhyst and Qoffset for a given NES state, or different scaling factors can be configured for Qhyst and Qoffset.

In IDLE/Inactive states, the WTRU may start such measurements even before the reception on determination of an NES state change of the serving cell, possibly triggered by reception of an indication or signaling from the NW (e.g., group common L1/L2 signaling, broadcast signaling (e.g., part of NES SIB) or configuration, or an RRC reconfiguration message), and the WTRU may start a timer following the reception of such indication to perform the measurements within a configured or predetermined time window. The WTRU may only measure a subset of cells or frequency layers that meet conditions described herein for NES specific CHO conditions and selection, cells indicated or prioritized part of this indication (e.g., part of an NES SIB), cells configured as alternate cells, etc. Following the reception of such indication, the WTRU may start measurements even if the current measurement on the camped cell and/or frequency layer is above the configured threshold for cell selection. This indication may also indicate a list of cells to measure, measurement resources (measurement objects, IDs, gaps, reporting configs, and/or quantity configs), associated priorities for cell re-selection, and/or associated NES states.

The NES state change indication received by the WTRU may include time information (e.g., NES state to change to medium sleep within x ms). In such a case, the WTRU may perform the update of the cell reselection configuration/behavior changes according to any of the solutions discussed above in one or more of the following ways. The WTRU may perform the update immediately on the reception of the NES state change indication. The WTRU may perform the update when the NES state change becomes effective (e.g., timer expires that was started with a value equal to the indicated anticipated NES state change). The WTRU may perform the update any time between the reception of the indication of the NES state change (or anticipated change) and when the NES state change actually takes effect. The WTRU may decide to apply immediately or when the NES change becomes effective, depending on the current and upcoming NES state change. For example, if the NES state is changing from full operational mode to light sleep, the WTRU may wait until the indicated time of NES state change to perform the update of any of the relevant cell re-selection configuration/behavior, while if the NES state is changing from light sleep mode to deep sleep (or to be turned off completely), the WTRU may perform all the relevant cell re-selection configuration/behavior updates immediately without waiting until the NES state change takes effect. The WTRU may perform the update depending on current WTRU conditions such as battery level, configured bearer/traffic type, etc., (e.g., while in INACTIVE state, immediately apply the updates if the WTRU has bearers that have very delay sensitive but wait until the NES state change takes effect otherwise).

The WTRU may send an indication to the network regarding its change of behavior related to any of the changes related to cell re-selection discussed above. However, since the WTRU is in IDLE/INACTIVE, it is not desirable to send the indications each time the configuration/behavior changes according to any of the solutions discussed above. Instead, the WTRU may keep the changes in a log and send them to the network when it transitions to CONNECTED mode. This log, for example, could be part of some other information the WTRU keeps while in IDLE/INACTIVE mode, such as WTRU mobility history (e.g., where the cell re-selection history stored in that may indicate further details regarding the cell re-selection behavior/configuration at that time, e.g., indicating that the cell re-selection happened due to a cell re-selection parameter/threshold update that was triggered due to NES state change of a serving or a neighbor cell).

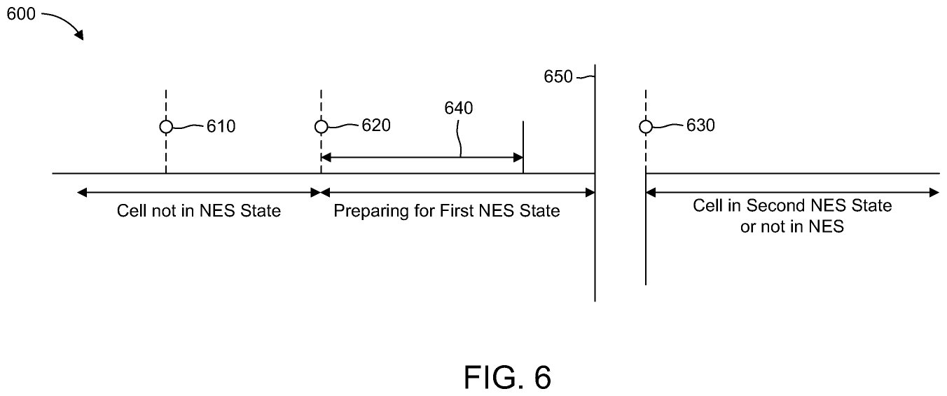

FIG. 6 illustrates an example 600. In example 600, a NES state may be associated with Cell DTX, cell turn off, or a state prior to cell turn off. The measurement configuration may include an ID, measurement gaps, measurement objects, and/or measurement reporting configuration parameters, as described herein.

Measurements for the WTRU may include inter-cell, inter-frequency, inter-RAT, BFD, RRM, and/or RLM measurements or example. When the cell is not an NES state, at 610, example 600 includes a WTRU receiving one or more measurements configurations from a cell where each configuration includes information indicating to which network energy savings stack (NES) state the configuration is application.

Preparation may occur for a first NES state, at 620, the WTRU receives signaling associated with activating a first NES state and determines which measurement configurations are applicable to the first NES state. The signaling may include, for example, explicit NES indication or CHO reconfiguration associated with NES. This signaling may be explicitly layer 1, layer 2, or CHO configuration.

During the time window 640, the WTRU performs and reports measurements using the NES measurement configuration applicable to the first NES stat. The WTRU may cease perming measurements other than the NES configured measurements. The time window 640 t may be configured at 610 and/or indicated with the NES signaling at 620.

At 650, the cell in first NES state (i.e., cell turns off). The cell may be in a second NES state or not in NES state, at 630, the WTRU receives signaling associated with activating a second NES state or deactivating NES. In the case of deactivation, the WTRU may use one or more measurement configurations not associated with any NES state (i.e., regular measurements).

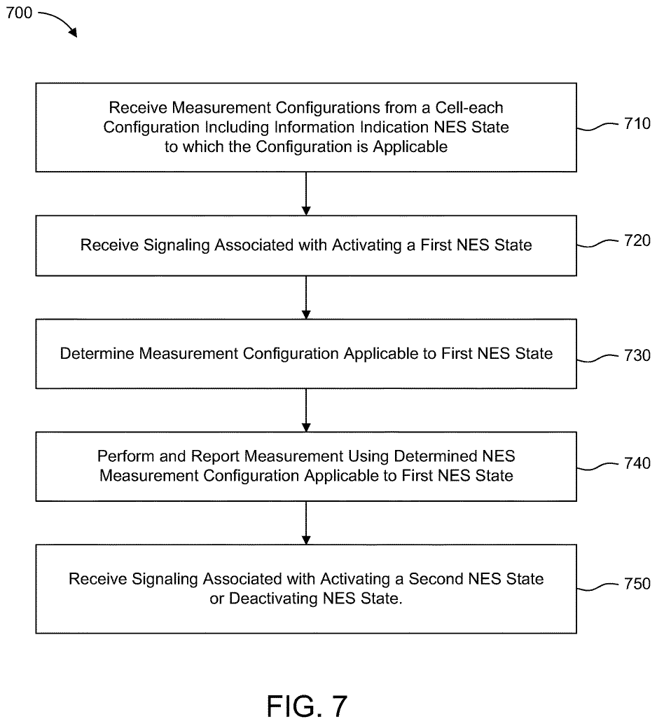

FIG. 7 illustrates a method 700 for WTRU measurements in an energy savings network. Method 700 includes at 710, receiving measurement configurations from a cell. The measurements configurations may include information indicating the NES state to which the configuration is applicable. At 720, method 700 includes receiving signals associated with activating a first NES state. These signals may be explicit NES indication or CHO reconfiguration messages associated with NES state, for example. The signals may be explicit in layer 1 or layer 2 or a CHO configuration.

At 730, method 700 includes determining the measurement configuration(s) application to the first NES state. At 740, method 700 performs and reports measurements using determined NES measurement configuration(s) application to the first NES state. At 750, method 700 includes receiving signaling associated with activating a second NES state or deactivating the NES state. If a deactivation occurs, the WTRU may use one or more measurement configuration(s) not associated with any NES state (i.e., regular measurements).

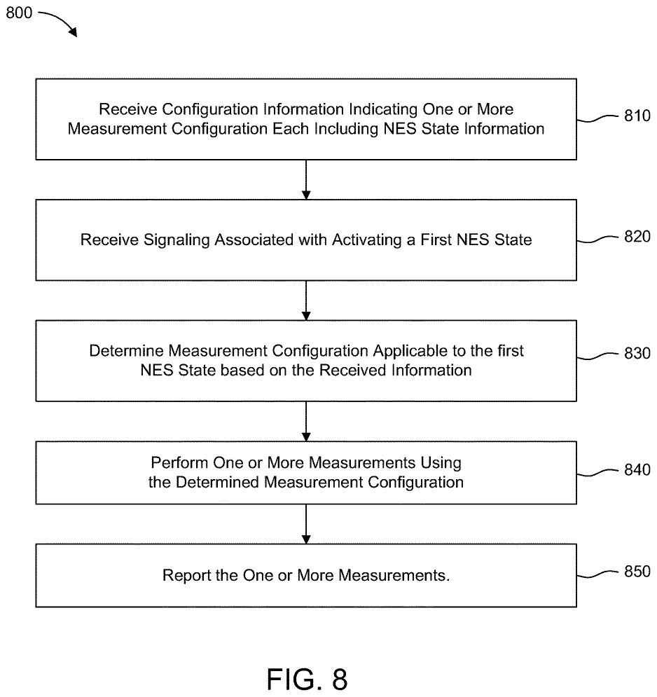

FIG. 8 illustrates a method 800 performed in a WTRU. Method 800 includes receiving configuration information indicating one or more measurement configurations where each of the one or more measurement configurations includes NES state information that indicates one or more network energy saving (NES) states to which the measurement configuration is applicable at 810. At 820, method 800 includes receiving signaling associated with activating a first NES state of the indicated one or more NES states. At 830, method 800 includes determining a measurement configuration applicable to the first NES state based on the received information. At 840, method 800 includes performing one or more measurements using the determined measurement configuration. At 850, method 800 includes reporting the one or more measurements. In method 800, the measurements may be performed or reported are during a time period that is configured or indicated for the first NES state. In method 800, the signaling associated with activating the first NES state may indicate at least one of activation of the first NES state, when the first NES state is to be activated, or a time period during which the first NES state can be activated. In method 800, the signaling associated with activating the first NES state may include a conditional handover (CHO) configuration or reconfiguration associated with the first NES state.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed in a wireless transmit receive unit (WTRU), the method comprising:
receiving configuration information indicating one or more measurement configurations where each of the one or more measurement configurations includes NES state information that indicates one or more network energy saving (NES) states to which the measurement configuration is applicable, wherein the one or more NES states is associated with a synchronization signal block (SSB) periodicity and an SSB signal;
receiving signaling associated with activating a first NES state of the indicated one or more NES states;
determining a measurement configuration applicable to the first NES state based on the received configuration information;
performing one or more measurements using the determined measurement configuration and the associated SSB periodicity; and
reporting the one or more measurements.

2. The method of claim 1, wherein the measurements are performed during a measurement time period that is configured for the first NES state.

3. The method of claim 1, wherein the measurements are reported during a reporting time period that is configured for the first NES state.

4. The method of claim 1, wherein the signaling associated with activating the first NES state indicates at least one selected from the group consisting of activation of the first NES state, when the first NES state is to be activated, and an activation time period during which the first NES state can be activated.

5. The method of claim 1, wherein the signaling associated with activating the first NES state includes at least one of a conditional handover (CHO) configuration associated with the first NES state or a CHO reconfiguration associated with the first NES state.

6. (canceled)

7. The method of claim 1, further comprising receiving signaling associated with activating a second NES state of the indicated one or more NES states.

8. The method of claim 1, further comprising deactivating the first NES state.

9. The method of claim 1, further comprising utilizing one or more measurement configurations not associated with any NES state.

10. The method of claim 1, wherein the one or more measurements include at least one measurement of a neighbor cell.

11. A wireless transmit receive unit (WTRU) comprising:
a processor; and
a transceiver communicatively coupled to the processor,
the processor and transceiver operating to:
receive configuration information indicating one or more measurement configurations where each of the one or more measurement configurations includes NES state information that indicates one or more network energy saving (NES) states to which the measurement configuration is applicable, wherein the one or more NES states is associated with a synchronization signal block (SSB) periodicity and an SSB signal;
receive signaling associated with activating a first NES state of the indicated one or more NES states;
determine a measurement configuration applicable to the first NES state based on the received configuration information;
perform one or more measurements using the determined measurement configuration and the associated SSB periodicity; and
report the one or more measurements.

12. The WTRU of claim 11, wherein the measurements are performed during a measurement time period that is configured for the first NES state.

13. The WTRU of claim 11 or 12, wherein the measurements are reported during a reporting time period that is configured for the first NES state.

14. The WTRU of claim 11, wherein the signaling associated with activating the first NES state indicates at least one selected from the group consisting of activation of the first NES state, when the first NES state is to be activated, and an activation time period during which the first NES state can be activated.

15. The WTRU of claim 11, wherein the signaling associated with activating the first NES state includes at least one of a conditional handover (CHO) configuration associated with the first NES state or a CHO reconfiguration associated with the first NES state.

16. (canceled)

17. The WTRU of claim 11, wherein the processor and transceiver are further configured to receive signaling associated with activating a second NES state of the indicated one or more NES states.

18. The WTRU of claim 11, wherein the processor and transceiver are further configured to deactivate the first NES state.

19. The WTRU of claim 11, wherein the processor and transceiver are further configured to utilize one or more measurement configurations not associated with any NES state.

20. The WTRU of claim 11, wherein the one or more measurements include at least one measurement of a neighbor cell.

21. The method of claim 1, wherein the measurement configuration includes at least one of the group consisting of: a measurement object, a measurement gap, and an SS/PBCH block measurement timing configuration (SMTC) configuration.

22. The WTRU of claim 11, wherein the measurement configuration includes at least one of the group consisting of: a measurement object, a measurement gap, and an SS/PBCH block measurement timing configuration (SMTC) configuration.
